(19) United States
(12) Patent Application Publication
(10) Pub. No.: US 2018/0084782 A1
(43) Pub. Date: Mar. 29, 2018

(54) METHOD OF CONTROL OF STINKBUGS

(71) Applicant: Syngenta Participations AG, Basel (CH)

(72) Inventors: Jerome Yves CASSAYRE, Stein (CH); Andre JEANGUENAT, Stein (CH); Elke Maria HILLESHEIM, Stein (CH)

(73) Assignee: Syngenta Participations AG, Basel (CH)

(21) Appl. No.: 15/571,575

(22) PCT Filed: Apr. 27, 2016
(86) PCT No.: PCT/EP2016/059447

§ 371 Date: Nov. 3, 2017

(30) Foreign Application Priority Data
May 5, 2015 (EP) 15166389.5
Jun. 17, 2016 (EP) 15172455.6

(51) Int. Cl. A01N 53/00

(52) U.S. Cl. CPC A01N 53/00

(57) ABSTRACT

The present invention relates to methods for controlling and/or preventing infestation of stinkbugs, comprising applying to a crop of plants, the locus thereof, or propagation material thereof, a compound of formula I wherein R¹, R^{6a}, R^{6b}Q, W, A₁, A₂, A₃, A₄, Z₁, Z₂ and Z₃ are as defined in the description.

### TECHNICAL FIELD

The present invention relates to methods for controlling and/or preventing infestation of stinkbugs, particularly stinkbugs of the genus Euschistus, more particularly Euschistus heros.

### BACKGROUND

The present invention relates to methods of pest control in crops. Stinkbugs (Hemiptera Pentatomidae) are true bugs which can be significant pests when present in large numbers. The nymphs and adults have piercing mouthparts which most use to suck sap from plants. According to Stewart et al., Soybean Insects-Stinkbugs, University of Tennessee Institute of Agriculture, W200 09-0098, stinkbugs are probably the most common pest problem in soybean. Although they may feed on many parts of the plant, they typically target developing seed including the pods, meaning that injury to soybean seed is the primary problem associated with stinkbug infestations. Of the complex of sucking bugs that occur in cultivation, the brown stinkbug Euschistus heros is currently considered to be the most abundant species in northern Paraná to Central Brazil (Corrêa-Ferreira & Panizzi, 1999), and is a significant problem in soybean (Schmidt et al., 2003). The bugs occur in soybeans from the vegetative stage and are harmful from the beginning of pod formation until grain maturity. They cause damage to the seed (Galileo & Heinrichs 1978a, Panizzi & Slansky Jr., 1985) and can also open the way to fungal diseases and cause physiological disorders, such as soybean leaf retention (Galileo & Heinrichs 1978, Todd & Herzog, 1980).

Control of stinkbugs is often vital to prevent significant economic damage. Insecticides commonly used to control stinkbugs include pyrethroids, neonicotinoids and organophosphates, although pyrethroid insecticides are usually the method of choice for controlling stinkbugs. However, there are increasing problems with insecticide resistance, particularly in brown stinkbug populations and particularly to pyrethroids. Euschistus heros can also be difficult to manage using organophosphates or endosulfan (Sosa-Gomez et al., 2009). There is therefore a need for effective alternative methods of controlling stinkbugs.

Compounds that are active as pest-control agents by antagonism of the gamma-aminobutyric acid (GABA)-gated chloride channel have been described in WO 2012/107434 and WO 2014/122083.

### DESCRIPTION OF THE EMBODIMENTS

The applicant has now surprisingly found that particular compounds from this class of gamma-aminobutyric acid (GABA)-gated chloride channel antagonists are highly effective at controlling stinkbugs. It has also surprisingly been found that the structure activity relationship for activity against stinkbugs is very sensitive and that particular compounds exhibit a significantly higher activity against stinkbugs than structurally very similar compounds. These highly active compounds therefore represent an important new solution for safeguarding crops from stinkbugs, particularly where stinkbugs are resistant to current methods.

Thus, as embodiment 1, there is provided a method of controlling and/or preventing infestation of stinkbugs comprising applying to a crop of plants, the locus thereof, or propagation material thereof, a compound of formula (I)

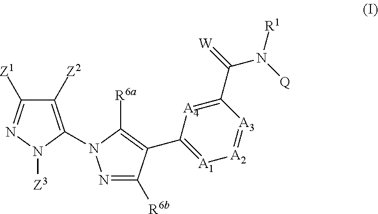

wherein

R¹ is selected from H, C₁₋C₆-alkyl, C₃₋C₆ alkenyl, C₃₋C₆alkinyl, C₃₋C₇ cycloalkyl, C₃₋C₇ cycloalkyl-C₁₋C₃-alkyl, C₁₋C₆alkylcarbonyl, C₁₋C₆-alkoxycarbonyl, aryl(C₁₋C₃)-alkyl and hetroaryl(C₁₋C₃)-alkyl, wherein each of C₁₋C₆-alkyl, C₃₋C₆ alkenyl, C₃₋C₆ alkinyl, C₃₋C₇ cycloalkyl, C₃₋C₇ cycloalkyl-C₁₋C₃-alkyl, C₁₋C₆-alkylcarbonyl, C₁₋C₆-alkoxycarbonyl, aryl(C₁₋C₃)-alkyl and heteroaryl(C₁₋C₃)-alkyl is unsubstituted or substituted with 1 to 5 substituents independently selected from halogen, cyano, C₁₋C₆-alkoxy and C₁₋C₆-alkoxycarbonyl: Q is selected from H, hydroxy, HC(═O)—, C₁₋C₆-alkyl, C₁₋C₆-alkoxy, C₃₋C₆ alkenyl, C₃₋C₆ alkinyl, C₃₋C₇ cycloalkyl, C₃₋C₇ heterocycloalkyl, C₃₋C₇ cycloalkyl-C₁₋C₃-alkyl, C₁₋C₃-alkyl-C₃₋C₇ cycloalkyl, aryl(C₁₋C₃)-alkyl, heteroaryl(C₁₋C₃)-alkyl, N—C₁₋C₆-alkylamino, N—C₁₋C₆-alkylcarbonylamino and N,N-di (C₁₋C₆-alkyl)amino, wherein each of C₁₋C₆-alkyl, C₁₋C₆-alkyl, C₁₋C₆-alkoxy, C₃₋C₆ alkenyl, C₃₋C₆ alkinyl, C₃₋C₇ cycloalkyl, C₃₋C₇ heterocycloalkyl, C₃₋C₇ cycloalkyl-C₁₋C₃-alkyl, C₁₋C₃-alkyl-C₃₋C₇ cycloalkyl, aryl(C₁₋C₃)-alkyl, heteroaryl(C₁₋C₃)-alkyl, N—C₁₋C₆-alkylamino, N—C₁₋C₆-alkylcarbonylamino and N,N-di (C₁₋C₆-alkyl)amino is unsubstituted or substituted with 1 to 5 substituents independently selected from halogen, hydroxyl, nitro, amino, cyano, C₁₋C₆-alkoxy, C₁₋C₆-alkoxycarbonyl, hydroxycarbonyl, C₁₋C₆-alkylcarbamoyl, C₃₋C₆-cycloalkylcarbamoyl and phenyl;

A₁ is CR² or N;

A₂ is CR³ or N;

A₃ is CR⁴ or N;

A₄ is CR⁵ or N;

with the proviso that no more than 3 of A₁, A₂, A₃ and A₄ are N;

R², R³, R⁴ and R⁵ are independently selected from H, halogen, cyano, nitro, C₁₋C₆-alkyl, C₁₋C₆-alkyl, C₁₋C₆-alkoxy, N—C₁₋C₆-alkoxy-imino-C₁₋C₃-alkyl, C₁₋C₆-alkylsulfanyl, C₁₋C₆-alkylsulfinyl, C₁₋C₆-alkylsulfonyl, N—C₁₋C₆-alkylamino and N,N-di-C₁₋C₆-alkylamino, wherein each of C₁₋C₆-alkyl, C₁₋C₆-alkoxy, N-C₁₋C₆-alkoxy-imino-C₁₋C₃-alkyl, C₁₋C₆-alkylsulfanyl, C₁₋C₆-alkylsulfinyl, C₁₋C₆-alkylsulfonyl, N—C₁₋C₆-alkylamino and N,N-di-C₁₋C₆-alkylamino is unsubstituted or substituted with 1 to 5 substituents independently selected from halogen, hydroxy, nitro, amino, cyano, C₁₋C₆-alkoxy, C₁₋C₆-alkoxycarbonyl, hydroxycarbonyl, C₁₋C₆-alkylcarbamoyl, C₃₋C₆-cycloalkylcarbamoyl and phenyl;

W is O or S;

R^{6a} and R^{6b} are independently selected from H, halogen, cyano, nitro, amino, C₁₋C₆-alkyl, C₁₋C₆-alkoxy, C₁₋C₆-alkylcarbonyl, C₁₋C₆-alkylsulfanyl, C₁₋C₆-alkylsulfinyl, C₁₋C₆-alkylsulfonyl, wherein each of C₁₋C₆-alkyl, C₁₋C₆-alkoxy, C₁₋C₆-alkylcarbonyl, C₁₋C₆-alkylsulfanyl, C₁₋C₆-alkylsulfinyl, C₁₋C₆-alkylsulfonyl is unsubstituted or substituted with 1 to 5 halogen;

Z¹ is selected from C₁₋C₆-halogenalkyl, C₃₋C₆-cycloalkyl and C₃₋C₆-halogencycloalkyl, wherein each of C₁₋C₆-halogenalkyl, C₃₋C₆-cycloalkyl and C₃₋C₆-halogencycloalkyl is unsubstituted or substituted with 1 to 5 substituents independently selected from halogen, hydroxy, nitro, amino, cyano, C₁₋C₆-alkoxy, C₁₋C₆-alkoxycarbonyl, hydroxycarbonyl, C₁₋C₆-alkylcarbamoyl, C₃₋C₆-cycloalkylcarbamoyl and phenyl;

Z² is selected from H, halogen, cyano, nitro, amino, C₁₋C₆-alkyl, C₁₋C₆-alkylcarbonyl, C₁₋C₆-alkylsulfanyl, C₁₋C₆-alkylsulfinyl and C₁₋C₆-alkylsulfonyl, wherein each of C₁₋C₆-alkyl, C₁₋C₆-alkylcarbonyl, C₁₋C₆-alkylsulfanyl, C₁₋C₆-alkylsulfinyl and C₁₋C₆-alkylsulfonyl is unsubstituted or substituted with 1 to 5 substituents independently selected from halogen, hydroxy, nitro, amino, cyano, C₁₋C₆-alkoxy, C₁₋C₆-alkoxycarbonyl, hydroxycarbonyl, C₁₋C₆-alkylcarbamoyl, C₃₋C₆-cycloalkylcarbamoyl and phenyl; Z³ is selected from C₁₋C₆-alkyl, C₁₋C₆-cycloalkyl, C₁₋C₆-alkenyl, C₁₋C₆-alkinyl, aryl and heteroaryl, wherein each of C₁₋C₆-alkyl, C₁₋C₆-cycloalkyl, C₁₋C₆-alkenyl, C₁₋C₆-alkinyl, aryl and heteroaryl is unsubstituted or substituted with 1 to 5 substituents independently selected from halogen, hydroxy, nitro, amino, cyano, C₁₋C₆-alkoxy, C₁₋C₆-alkoxycarbonyl, hydroxycarbonyl, C₁₋C₆-alkylcarbamoyl, C₃₋C₆-cycloalkylcarbamoyl and phenyl;

or an agrochemically acceptable salt or N-oxide thereof.

Embodiment 2: A method according to embodiment 1, wherein

R¹ is selected from H, methyl, ethyl, n-propyl, isopropyl, n-butyl, isobutyl, s-butyl, t-butyl, methoxymethyl, ethoxymethyl, propoxymethyl, methylcarbonyl, ethylcarbonyl, n-propylcarbonyl, isopropylcarbonyl, s-butylcarbonyl, t-butylcarbonyl, methoxycarbonyl, ethoxycarbonyl, n-propoxycarbonyl, isopropoxycarbonyl, s-butoxycarbonyl, t-butoxycarbonyl, cyanomethyl, 2-cyanoethyl, benzyl, 4-methoxybenzyl, pyrid-2-yl-methyl, pyrid-3-yl-methyl, pyrid-4-yl-methyl and 4-chlor-pyrid-3-yl-methyl; Q is selected from H, methyl, ethyl, n-propyl, 1-methylethyl, 1,1-dimethylethyl, 1-methylpropyl, n-butyl, 2-methylpropyl, 2-methylbutyl, hydroxyethyl, 2-hydroxypropyl, cyanomethyl, 2-cyanoethyl, 2-fluorethyl, 2,2-difluorethyl, 2,2,2-trifluorethyl, 1-trifluormethylethyl, 2,2-difluorpropyl, 3,3,3-trifluorpropyl, 2,2-dimethyl-3-fluorpropyl, cyclopropyl, 1-cyano-cyclopropyl, 1-methoxycarbonyl-cyclopropyl, 1-(N-methylcarbamoyl)cyclopropyl, 1-carbamoyl-cyclopropyl, 1-carbamothioyl-cyclopropyl, 1-(N-cyclopropylcarbamoyl)cyclopropyl, cyclopropyl-methyl, cyclobutyl, cyclopentyl, cyclohexyl, 1-cyclopropylethyl, bis(cyclopropyl)methyl, 2,2-dimethylcyclopropyl-methyl, 2-phenylcyclopropyl, 2,2-dichlorcyclopropyl, trans-2-chlorcyclopropyl, cis-2-chlorcyclopropyl, 2,2-difluorcyclopropyl, trans-2-fluorcyclopropyl, cis-2-fluorcyclopropyl, trans-4-hydroxycyclohexyl, 4-trifluormethylcyclohexyl, prop-2-enyl, 2-methylprop-2-enyl, prop-2-inyl, 1,1-dimethylbut-2-inyl, 3-chlor-prop-2-enyl, 3-fluor-prop-2-enyl, 3,3-dichlor-prop-2-enyl, 3,3-dichlor-1,1-dimethylprop-2-enyl, oxetan-3-yl, thietan-3-yl, l-oxido-thietan-3-yl, l,l-dioxido-thietan-3-yl, isoxazol-3-ylmethyl, l,2,4-triazol-3-ylmethyl, 3-methyloxetan-3-ylmethyl, benzyl, 2,6-difluorphenylmethyl, 3-fluorphenylmethyl, 2-fluorphenylmethyl, 2,5-difluorphenylmethyl, 1-phenylethyl, 4-chlorphenylethyl, 2-trifluormethylphenylethyl, 1-pyridin-2-ylethyl, pyridin-2-ylmethyl, 5-fluorpyridin-2-ylmethyl, (6-chlor-pyridin-3-yl)methyl, pyrimidin-2-ylmethyl, methoxy, 2-ethoxyethyl, 2-methoxyethyl, 2-(methylsulfanyl)ethyl, l-methyl-2-(ethylsulfanyl)ethyl, 2-methyl-1-(methylsulfanyl)propan-2-yl, methoxycarbonyl, methoxycarbonylmethyl, NH₂, N-ethylamino, N-allylamino, N,N-dimethylamino and N,N-diethylamino; or

Q is selected from phenyl, naphthyl, pyridazin, pyrazin, pyrimidin, triazin, pyridin, pyrazol, thiazol, isothiazol, oxazol, isoxazol, triazol, imidazol, furan, thiophen, pyrrol, oxadiazol, and thiadiazol, each of which is unsubstituted or substituted with 1 to 4 substituents independently selected from V;

V is selected from fluoro, chloro, bromo, iodo, Cyano, nitro, methyl, ethyl, difluormethyl, trichloromethyl, chlordifluoromethyl, dichlorofluoromethyl, trifluoromethyl, 1-fluoroethyl, 2-fluoroethyl, 2,2-difluoroethyl, 2,2,2-trifluoroethyl, 1,2,2,2-tetrafluoroethyl, 1-chloro-1,2,2,2-tetrafluoroethyl, 2,2,2-trichloroethyl, 2-chloro-2,2-difluoroethyl, 1,1-dilfluoroethyl, pentafluoroethyl heptafluoro-n-propyl, heptafluoro-isopropyl, nonafluoro-n-butyl, cyclopropyl, cyclobutyl, methoxy, ethoxy, n-propoxy, 1-methylethoxy, fluormethoxy, difluormethoxy, chloro-difluormethoxy, dichloro-fluoromethoxy, trifluoromethoxy, 2,2,2-trifluoroethoxy, 2-chloro-2,2-difluorethoxy, pentafluorethoxy, N-methoxyiminomethyl, l-(N-methoxyimino)-ethyl, methylsulfanyl, methylsulfonyl, methylsulfinyl, trifluormethylsulfonyl, trifluormethylsulfinyl, trifluormethylsulfanyl and N,N-dimethylamino;

W is O or S;

A₁ is CR² or N;

A₂ is CR³ or N;

A₃ is CR⁴ or N;

A₄ is CR⁵ or N;

with the proviso that no more than 3 of A₁, A₂, A₃ and A₄ are N;

R² and R⁵ are independently selected from H, methyl, fluoro and chloro;

R³ and R⁴ are independently selected from H, fluoro, chloro, bromo, iodo, cyano, nitro, methyl, ethyl, fluoromethyl, difluoromethyl, chlordifluormethyl, trifluormethyl, 2,2,2-trilfluoroethyl, methoxy, ethoxy, n-propoxy, 1-methylethoxy, fluoromethoxy, difluoromethoxy, chloro-difluoromethoxy, dichloro-fluoromethoxy, trifluoromethoxy, 2,2,2-trifluoroethoxy, 2-chloro-2,2-difluorethoxy, pentafluoroethoxy, N-methoxyiminomethyl, l-(N-methoxyimino)-ethyl, methylsulfanyl, trifluoromethylsulfanyl, methylsulfonyl, methylsulfinyl, trifluormethylsulfonyl and trifluormethylsulfinyl;

R^{6a} and R^{6b} are independently selected from halogen, cyano, nitro, amino, methyl, ethyl, propyl, 1-methylethyl, tert-butyl, trifluoromethyl, difluoromethyl, methoxy, ethoxy, trifluoromethoxy, 2,2-difluoroethoxy, 2,2,2-trifluoroethoxy, methylcarbonyl, ethylcarbonyl, trifluoromethylcarbonyl, methylsulfanyl, methylsulfinyl, methylsulfonyl, trifluoromethylsulfonyl, trifluoromethylsulfanyl and trilfluoromethylsulfinyl;

Z¹ is selected from methyl, ethyl, 1,1-dimethylethyl, difluoromethyl, trichloromethyl, chlorodifluoromethyl, dichlorofluoromethyl, trifluoromethyl, bromodichloromethyl, 1-fluoroethyl, 1-fluoro-1-methylethyl, 2-fluoroethyl, 2,2-difluorethyl, 2,2,2-trifluoroethyl, 1,2,2,2-tetrafluoroethyl, 1-chloro-1,2,2,2-tetrafluoroethyl, 2,2,2-trichloroethyl, 2-chloro-2,2-difluoroethyl, 1,1-difluoroethyl, pentafluoroethyl heptafluor-n-propyl, heptafluor-isopropyl, nonafluoro-n-butyl, cyclopropyl, 1-chlorocyclopropyl, 1-fluorocyclopropyl, 1-bromocyclopropyl, 1-cyano-cyclopropyl, 1-trifluoromehtyl-cyclopropyl, cyclobutyl and 2,2-Difluor-l-methyl-cyclopropyl;

Z² is selected from H, halogen, cyano, nitro, amino, methyl, ethyl, 1,1-dimethylethyl, difluoromethyl, trichloromethyl, chlorodifluoromethyl, dichlorofluoromethyl, trifluoromethyl, bromodichloromethyl, 1-fluoroethyl, 1-fluoro-1 methylethyl, 2-fluoroethyl, 2,2-difluoroethyl, 2,2,2-trifluoroethyl, 1,2,2,2-tetrafluoroethyl, 1-chlor-1,2,2,2-tetrafluoroethyl, 2,2,2-trichloroethyl, 2-chloro-2,2-difluoroethyl, 1,1-difluoroethyl, pentafluoroethyl heptafluoro-n-propyl, heptafluoro-isopropyl, nonafluoro-n-butyl, methylsulfanyl, methylsulfinyl, methylsulfonyl, ethylthio, ethylsulfinyl, ethylsulfonyl, trifluoromethylsulfanyl, trifluoromethylsulfinyl, trifluoromethylsulfonyl, chloro-difluoromethylsulfanyl, chloro-difluoromethylsulfinyl, chloro-difluoromethylsulfonyl, dichloro-fluoromethylsulfanyl, dichloro-fluoromethylsulfinyl, dichloro-fluoromethylsulfonyl; and

Z³ is selected from H, methyl, ethyl, n-propyl, isopropyl, n-butyl, isobutyl, s-butyl, t-butyl, ethenyl, 1-propenyl, 1-propinyl, 1-butinyl, difluoromethyl, trichloromethyl, chlorodifluoromethyl, dichlorofluoromethyl, trifluoromethyl, 1-fluoroethyl, 1 fluoro-1-methylethyl, 2-fluoroethyl, 2,2-difluoroethyl, 2,2,2-trifluoroethyl, phenyl, 2-chlorophenyl, 3-chlorophenyl, 4-chlorophenyl, 2,5-dichlorophenyl, 3,4-dichlorophenyl, 2,6-dichlorophenyl 2,6-dichloro-4-trifluoromethylphenyl and 3-chlor-5-trifluormethylpyridin-2-yl

Embodiment 3: A method according to embodiment 1 or 2, wherein

R¹ is H, methyl, ethyl, n-propyl, n-propylcarbonyl and propenyl;

Q is selected from 1-cyano-cyclopropyl, benzyl, cyclopropyl, 2-thienylmethyl, carbamothioylcyclopropyl, pyrid-4-yl, 2,2,2-trifluorethyl, methylsulfonyl, thietan-3-yl and 1-carbamoylcyclopropyl;

W is O;

A¹ and A4 are CH;

A² is CH or CF;

A³ is CH or CCl;

R^{6a} is H or methyl;

R^{6b} is H, methyl or CF₃;

Z¹ is CF₂CF₃;

Z² is CF₃;

Z³ is selected from methyl, ethyl, phenyl, 4-NO₂-phenyl and 3-chlorpyridin-2-yl.

Embodiment 4: A method according to embodiment 1, wherein

R¹ is H or methyl;

Q is selected from 1-cyano-cyclopropyl, benzyl, cyclopropyl, 2-thienylmethyl, carbamothioylcyclopropyl, pyrid-4-yl, 2,2,2-trifluorethyl, methylsulfonyl, thietan-3-yl and 1-carbamoylcyclopropyl;

W is O;

A¹ and A⁴ are CH;

A² is N;

A³ is CH or CCl;

R^{6a} is H or methyl;

R^{6b} is H, methyl or CF₃;

Z¹ is CF₂CF₃;

Z² is CF₃;

Z³ is methyl, ethyl, phenyl, 4-NO₂-phenyl, 3-chloropyridin-2-yl.

Embodiment 5: A method according to embodiment 1, wherein the compound is selected from a compound of formula (I)

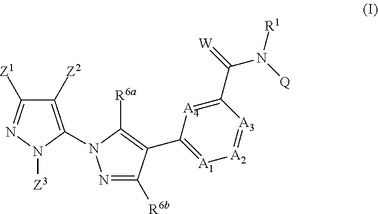

wherein Z¹, Z², Z3, R^{6a}, R^{6b}, A₁, A₂, A₃, A₄, W, Q and R¹ are as defined in the table below

| Ex | | | | | | | | | | | | |
|---|---|---|---|---|---|---|---|---|---|---|---|---|
| no | Z¹ | Z² | Z³ | R¹ | R^{6a} | R^{6b} | A₄ | A₃ | A₂ | A₁ | W | Q |
| Ic-2 | CF2CF3 | CF3 | CH3 | H | H | H | C—H | C—Cl | C—H | C—H | O | 1-Cyano-cyclopropyl |
| Ic-3 | CF2CF3 | CF3 | CH3 | H | H | H | C—H | C—Cl | C—H | C—H | O | Benzyl |
| Ic-4 | CF2CF3 | CF3 | CH3 | H | H | CF3 | C—H | C—Cl | C—H | C—H | O | Cyclopropyl |
| Ic-5 | CF2CF3 | CF3 | CH3 | H | CH3 | CF3 | C—H | C—Cl | C—H | C—H | O | Cyclopropyl |
| Ic-6 | CF2CF3 | CF3 | Phenyl | H | H | H | C—H | C—Cl | C—H | C—H | O | Cyclopropyl |
| Ic-7 | CF2CF3 | CF3 | Phenyl | H | H | H | C—H | C—Cl | C—H | C—H | O | 1-Cyano-cyclopropyl |
| Ic-8 | CF2CF3 | CF3 | 4-N02- | H | H | H | C—H | C—Cl | C—H | C—H | O | Cyclopropyl |
| | | | Phenyl | | | | | | | | | |
| Ic-9 | CF2CF3 | CF3 | CH3 | H | CH3 | CH3 | C—H | C—Cl | C—H | C—H | O | Cyclopropyl |
| Ic-10 | CF2CF3 | CF3 | CH3 | H | H | H | C—H | C—Cl | C—H | C—H | O | 2-Thienylmethyl |
| Ic-11 | CF2CF3 | CF3 | CH3 | H | H | H | C—H | C—Cl | C—H | C—H | O | 1- |
| | | | | | | | | | | | | Carbamothioylcyclopropyl |
| Ic-12 | CF2CF3 | CF3 | CH3 | H | H | CH3 | C—H | C—Cl | C—H | C—H | O | Cyclopropyl |
| Ic-13 | CF2CF3 | CF3 | CH3 | H | CH3 | H | C—H | C—Cl | C—H | C—H | O | Cyclopropyl |
| Ic-14 | CF2CF3 | CF3 | 3-Chlorpyridin-2-yl | H | H | H | C—H | C—Cl | C—H | C—H | O | Cyclopropyl |
| Ic-15 | CF2CF3 | CF3 | 3- | H | H | H | C—H | C—Cl | C—H | C—H | O | 1-Cyano-cyclopropyl |
| | | | Chlorpyridin-2-yl | | | | | | | | | |
| Ic-16 | CF2CF3 | CF3 | CH2CH3 | H | H | H | C—H | C—Cl | C—H | C—H | O | Cyclopropyl |
| Ic-17 | CF2CF3 | CF3 | CH3 | H | H | H | C—H | C—H | C—H | C—H | O | Benzyl |
| Ic-18 | CF2CF3 | CF3 | CH3 | H | H | H | C—H | C—H | C—H | C—H | O | Cyclopropyl |
| Ic-19 | CF2CF3 | CF3 | CH3 | H | H | H | C—H | C—H | C—H | C—H | O | 1-Cyano-cyclopropyl |
| Ic-20 | CF2CF3 | CF3 | CH3 | H | H | H | C—H | C—H | C—H | C—H | O | 2-Thienylmethyl |
| Ic-21 | CF2CF3 | CF3 | CH2CH3 | H | H | H | C—H | C—Cl | C—H | C—H | O | 1-Cyano-cyclopropyl |
| Ic-22 | CF2CF3 | CF3 | CH3 | H | H | H | C—H | C—Cl | C—H | C—H | O | Pyrid-4-yl |
| Ic-23 | CF2CF3 | CF3 | CH3 | H | H | H | C—H | C—Cl | C—H | C—H | O | 2,2,2-Trifluorethyl |
| Ic-24 | CF2CF3 | CF3 | CH3 | H | H | H | C—H | C—Cl | C—F | C—H | O | Cyclopropyl |
| Ic-25 | CF2CF3 | CF3 | CH3 | H | H | H | C—H | C—Cl | C—H | C—H | O | 4-Chlorphenyl |
| Ic-26 | CF2CF3 | CF3 | CH3 | H | H | H | C—H | C—Cl | C—H | C—H | O | Methylsulfonyl |
| Ic-27 | CF2CF3 | CF3 | CH3 | H | H | H | C—H | C—Cl | C—F | C—H | O | 1-Cyano-cyclopropyl |
| Ic-28 | CF2CF3 | CF3 | CH3 | H | H | H | C—H | C—Cl | C—H | C—H | O | Thietan-3-yl |
| Ic-29 | CF2CF3 | CF3 | CH3 | H | H | H | C—H | C—Cl | C—H | C—H | O | 1-Carbamoylcyclopropyl |
| Ic-30 | CF3 | CN | Me | H | H | H | C—H | C—Cl | C—H | C—H | O | cyclopropyl |
| Ic-31 | CF2CF3 | CF3 | Me | H | H | H | C—H | C—Cl | C—H | C—H | O | 2-oxo-2-[(2,2,2- |
| | | | | | | | | | | | | trifluoroethyl)amino]ethyl |
| Ic-32 | CF2CF3 | CF3 | Me | H | H | H | C—H | C—Cl | C—H | C—H | O | 1-(CF3)cyclopropyl |
| Ic-33 | CF2CF3 | CF3 | Me | H | H | H | C—F | C—H | C—H | C—H | O | cyclopropyl |
| Ic-34 | CF2CF3 | CF3 | Me | H | H | H | C—H | C—Br | C—H | C—H | O | 1-cyanocyclopropyl |
| Ic-35 | CF2CF3 | CF3 | Me | H | H | H | C—H | C—H | C—H | C—H | O | H |
| Ic-36 | CF2CF3 | CF3 | Me | H | H | H | C—H | C—F | C—H | C—H | O | 1-cyanocyclopropyl |
| Ic-37 | CF2CF3 | CF3 | Me | H | H | H | C—H | C—F | C—H | C—H | O | cyclopropyl |
| Ic-38 | CF2CF3 | CF3 | Me | H | H | H | C—H | C—H | C—F | C—H | O | 1-cyanocyclopropyl |
| Ic-39 | CF2CF3 | CF3 | Me | H | H | H | C—H | C—H | C—F | C—H | O | cyclopropyl |
| Ic-40 | CF2CF3 | CF3 | Me | H | H | H | C—F | C—H | C—H | C—H | O | 1-cyanocyclopropyl |
| Ic-41 | CF2CF3 | CF3 | Me | H | H | H | C—H | C—H | C—H | C—F | O | cyclopropyl |
| Ic-42 | CF2CF3 | CF3 | Me | H | H | H | C—H | C—H | C—H | C—F | O | 1-cyanocyclopropyl |
| Ic-43 | CF2CF3 | CF3 | Me | H | H | H | C—H | C—H | C—Cl | C—H | O | 1-cyanocyclopropyl |
| Ic-44 | CF2CF3 | CF3 | Me | H | H | H | C—H | C—H | C—Cl | C—H | O | cyclopropyl |
| Ic-45 | CF2CF3 | CF3 | Me | H | H | H | C—H | C—H | C—H | C—Cl | O | 1-cyanocyclopropyl |
| Ic-46 | CF2CF3 | CF3 | Me | H | H | H | C—H | C—H | C—H | C—Cl | O | cyclopropyl |
| Ic-47 | CF2CF3 | CF3 | Me | H | H | H | C—H | C—F | C—F | C—H | O | 1-cyanocyclopropyl |
| Ic-48 | CF2CF3 | CF3 | Me | H | H | H | C—H | C—F | C—H | C—Cl | O | 1-cyanocyclopropyl |
| Ic-49 | CF2CF3 | CF3 | Me | H | H | H | C—H | C—F | C—H | C—Cl | O | cyclopropyl |
| Ic-50 | CF3 | (E/Z) | Me | H | H | H | C—H | C—Cl | C—H | C—H | O | cyclopropyl |
| | | (hydroxyimino)methyl | | | | | | | | | | |
| Ic-51 | CF3 | (E/Z) | Me | H | H | H | C—H | C—Cl | C—H | C—H | O | cyclopropyl |
| | | (methoxyimino)methyl | | | | | | | | | | |
| Ic-52 | CF3 | formyl | Me | H | H | H | C—H | C—Cl | C—H | C—H | O | cyclopropyl |
| Ic-53 | CF3 | CN | Me | H | H | H | C—H | C—Cl | C—H | C—H | O | 1-cyanocyclopropyl |
| Ic-54 | CF2CF3 | CF3 | Me | H | H | H | C—H | C—H | C—Me | C—H | O | cyclopropyl |
| Ic-55 | CF2CF3 | CF3 | Me | H | H | H | C—H | C—F | C—F | C—H | O | cyclopropyl |
| Ic-56 | CF2CF3 | CF3 | Me | H | H | H | C—H | C—H | C—Me | C—H | O | 1-cyanocyclopropyl |
| Ic-57 | CF2CF3 | CF3 | Me | H | H | H | C—H | C—H | C—H | C—Me | O | cyclopropyl |
| Ic-58 | CF2CF3 | CF3 | Me | H | H | H | C—H | C—H | C—H | C—Me | O | 1-cyanocyclopropyl |
| Ic-59 | CF2CF3 | CF3 | Me | H | H | H | C—H | C—H | C—CF3 | C—H | O | cyclopropyl |
| Ic-60 | CF2CF3 | CF3 | Me | H | H | H | C—H | C—H | C—CF3 | C—H | O | 1-cyanocyclopropyl |
| Ic-61 | CF2CF3 | CF3 | Me | H | H | H | C—H | C—H | C—F | C—F | O | cyclopropyl |
| Ic-62 | CF2CF3 | CF3 | Me | H | H | H | C—H | C—H | C— | C—H | O | cyclopropyl |
| Ic-63 | CF2CF3 | CF3 | Me | H | H | H | C—H | C—H | C—OMe | C—H | O | 1-cyanocyclopropyl |
| Ic-64 | CF2CF3 | CF3 | Me | H | H | H | C—H | C—H | C—F | C—F | O | 1-cyanocyclopropyl |
| Ic-65 | CF2CF3 | CF3 | Me | H | H | H | C—H | C—N02 | C—H | C—H | O | 1-cyanocyclopropyl |
| Ic-66 | CF2CF3 | CF3 | Me | H | H | H | C—H | C—N02 | C—H | C—H | O | cyclopropyl |
| Ic-67 | CF2CF3 | CF3 | Me | H | H | H | C—H | C—OMe | C—H | C—H | O | 1-cyanocyclopropyl |
| Ic-68 | CF2CF3 | CF3 | Me | H | H | H | C—H | C—OMe | C—H | C—H | O | cyclopropyl |
| Ic-69 | CF3 | CH2OH | Me | H | H | H | C—H | C—Cl | C—H | C—H | O | cyclopropyl |
| Ic-70 | CF2CF3 | CF3 | Me | H | H | H | C—H | C—H | N | C—H | O | cyclopropyl |
| Ic-71 | CF2CF3 | CF3 | Me | H | H | H | C—H | C—H | N | C—H | O | 1-cyanocyclopropyl |
| Ic-72 | CF2CF3 | CF3 | Me | H | H | H | C—H | N | C—H | C—F | O | cyclopropyl |
| Ic-73 | CF2CF3 | CF3 | Me | H | H | H | C—H | N | C—H | C—F | O | 1-cyanocyclopropyl |
| Ic-74 | CF2CF3 | CF3 | Me | H | H | H | C—H | C—H | C—OCF [symbol] | C—H | O | cyclopropyl |
| Ic-75 | CF2CF3 | CF3 | Me | H | H | H | C—H | C—H | C—OCF [symbol] | C—H | O | 1-cyanocyclopropyl |
| Ic-76 | CF2CF3 | CF3 | Me | H | H | H | C—H | N | C—H | C—H | O | 1-cyanocyclopropyl |
| Ic-77 | CF2CF3 | CF3 | Me | H | H | H | C—H | C—Cl | C—H | C—H | O | 2-fluoroethyl |
| Ic-78 | CF2CF3 | CF3 | Me | H | H | H | C—H | C—Cl | C—H | C—H | O | 2,2-difluoroethyl |
| Ic-79 | CF2CF3 | CF3 | Me | H | H | H | C—H | C—Cl | C—H | C—H | O | 2-methylcyclopropyl |
| Ic-80 | CF2CF3 | CF3 | Me | H | H | H | C—H | C—Cl | C—H | C—H | O | 2,2-difluoropropyl |
| Ic-81 | CF2CF3 | CF3 | Me | H | H | H | C—H | C—Cl | C—H | C—H | O | 2-fluorocyclopropyl |
| Ic-83 | CF2CF3 | CF3 | Me | H | H | H | C—H | C—Cl | N | C—H | O | 1-cyanocyclopropyl |
| Ic-84 | CF2CF3 | CF3 | Me | H | H | H | C—H | C—Me | N | C—H | O | cyclopropyl |
| Ic-85 | CF2CF3 | CF3 | Me | H | H | H | C—H | C—Me | N | C—H | O | 1-cyanocyclopropyl |
| Ic-86 | CF2CF3 | CF3 | Me | H | H | H | C—H | C—OMe | N | C—H | O | cyclopropyl |
| Ic-87 | CF2CF3 | CF3 | Me | H | H | H | C—H | C—OMe | N | C—H | O | 1-cyanocyclopropyl |
| Ic-88 | CF2CF3 | CF3 | Me | H | H | H | C—H | N | C—Cl | C—H | O | cyclopropyl |
| Ic-89 | CF2CF3 | CF3 | Me | H | H | H | C—H | N | C—Cl | C—H | O | 1-cyanocyclopropyl |
| Ic-90 | CF2CF3 | CF3 | Me | H | H | H | C—H | C—Cl | C—Me | C—H | O | cyclopropyl |
| Ic-91 | CF2CF3 | CF3 | Me | H | H | H | C—H | C—Cl | C—Me | C—H | O | 1-cyanocyclopropyl |
| Ic-92 | CF2CF3 | CF3 | Me | H | H | H | C—H | C—Cl | C—H | C—F | O | cyclopropyl |
| Ic-93 | CF2CF3 | CF3 | Me | H | H | H | C—H | C—Cl | C—H | C—F | O | 1-cyanocyclopropyl |
| Ic-94 | CF2CF3 | CF3 | Me | H | H | H | C—H | C—Cl | C—Cl | C—H | O | cyclopropyl |
| Ic-95 | CF2CF3 | CF3 | Me | H | H | H | C—H | C—Cl | C—Cl | C—H | O | 1-cyanocyclopropyl |
| Ic-96 | CF2CF3 | CF3 | Me | Me | H | H | C—H | C—Cl | C—H | C—H | O | 1-cyanocyclopropyl |
| Ic-97 | CF2CF3 | CF3 | Me | Me | H | H | C—H | C—Cl | C—H | C—H | O | 1- |
| Ic-98 | CF3 | (E/Z) (hydroxyimino)methyl | Me | H | H | H | C—H | C—Cl | C—H | C—H | O | 1-cyanocyclopropyl |
| Ic-99 | CF3 | (E/Z) | Me | H | H | H | C—H | C—Cl | C—H | C—H | O | 1-cyanocyclopropyl |
| | | (methoxyimino)methyl | | | | | | | | | | |
| Ic-100 | CF3 | cyclopropylcarbamoyl | Me | H | H | H | C—H | C—Cl | C—H | C—H | O | cyclopropyl |
| Ic-101 | CF3 | cyclopropylcarbamoyl | Me | H | H | H | C—H | C—Cl | C—H | C—H | O | 1-cyanocyclopropyl |
| Ic-102 | CF3 | formyl | Me | H | H | H | C—H | C—Cl | C—H | C—H | O | 1-cyanocyclopropyl |
| Ic-103 | CF3 | CH2F | Me | H | H | H | C—H | C—Cl | C—H | C—H | O | cyclopropyl |
| Ic-104 | CF3 | CH2OH | Me | H | H | H | C—H | C—Cl | C—H | C—H | O | 1-cyanocyclopropyl |
| Ic-105 | CF2CF3 | CF3 | Me | H | H | H | N | C—H | C—H | C—H | O | 1-cyanocyclopropyl |
| Ic-106 | CF2CF3 | CF3 | Me | H | H | H | C—F | C—Cl | C—H | C—H | O | cyclopropyl |
| Ic-107 | CF2CF3 | CF3 | Me | H | H | H | C—F | C—Cl | C—H | C—H | O | 1-cyanocyclopropyl |
| Ic-108 | CF2CF3 | CF3 | Me | H | H | H | C—H | C—Cl | C—H | C—H | O | 3- |
| | | | | | | | | | | | | (methylsulfanyl)cyclobutyl |
| Ic-109 | CF2CF3 | CF3 | Me | H | H | H | C—H | C—Cl | C—H | C—H | O | prop-2-yn-1-yl |
| Ic-110 | CF2CF3 | CF3 | Me | H | H | H | C—H | C—Cl | C—H | C—H | O | 1,1,1-trifluoropropan-2-yl |
| Ic-111 | CF2CF3 | CF3 | Me | H | H | H | C—H | C—Cl | C—H | C—H | O | buta-2,3-dien-1-yl |
| Ic-112 | CF2CF3 | CF3 | Me | H | H | H | C—H | C—Cl | C—H | C—H | O | 3-chloroprop-2-en-1-yl |
| Ic-113 | CF2CF3 | CF3 | Me | H | H | H | C—H | C—Cl | C—H | C—H | O | isopropyl |
| Ic-114 | CF3 | CH2Cl | Me | H | H | H | C—H | C—Cl | C—H | C—H | O | cyclopropyl |
| Ic-115 | CF3 | CH2F | Me | H | H | H | C—H | C—Cl | C—H | C—H | O | 1-cyanocyclopropyl |
| Ic-116 | CF2CF3 | CF3 | Me | H | H | H | C—H | C—Cl | C—H | C—H | O | 1-oxidothietan-3-yl |
| Ic-117 | CF2CF3 | CF3 | Me | H | H | H | C—H | C—Cl | C—H | C—H | O | 1,1-dioxidothietan-3-yl |
| Ic-118 | CF2CF3 | CF3 | Me | H | H | H | C—H | C—(E/Z)- | C—H | C—H | O | cyclopropyl |
| | | | | | | | | (methoxyimino)methyl | | | | |
| Ic-119 | CF2CF3 | CF3 | Me | H | H | H | C—H | C—Cl | C—H | C—H | O | 2- |
| | | | | | | | | | | | | (methylsulfanyl)cyclobutyl |
| Ic-120 | CF2CF3 | CF3 | Me | H | H | H | C—H | C—Cl | C—H | C—H | O | 2- |
| | | | | | | | | | | | | [(methylsulfanyl)methyl]cyclobutyl |
| Ic-121 | CF2CF3 | formyl | Me | H | H | H | C—H | C—Cl | C—H | C—H | O | 1-cyanocyclopropyl |
| Ic-122 | CF2CF3 | CF3 | Me | H | H | H | C—H | C—Cl | C—H | C—H | O | 3- |
| | | | | | | | | | | | | (methylsulfonyl)cyclobutyl |
| Ic-123 | CF2CF3 | CF3 | Me | H | H | H | C—H | C—Cl | C—H | C—H | O | 2- |
| | | | | | | | | | | | | [(methylsulfinyl)methyl]cyclobutyl |
| Ic-124 | CF2CF3 | CF3 | Me | H | H | H | C—H | C—Cl | C—H | C—H | O | (1S,2R)-2- |
| | | | | | | | | | | | | (methylsulfonyl)cyclobutyl |
| Ic-125 | CF2CF3 | CF3 | Me | H | H | H | C—H | C—Cl | C—H | C—H | O | 2- |
| | | | | | | | | | | | | (methylsulfinyl)cyclobutyl |
| Ic-126 | CF3 | CF3 | Me | H | H | H | C—H | C—Cl | C—H | C—H | O | cyclopropyl |
| Ic-127 | CF3 | CF3 | Me | H | H | H | C—H | C—Cl | C—H | C—H | O | 1-cyanocyclopropyl |
| Ic-128 | CF2CF3 | CF3 | Me | H | H | H | C—H | C—Cl | C—H | C—H | O | 3-cyanothietan-3-yl |
| Ic-129 | CF2CF3 | CF3 | Me | H | H | H | C—H | C—Me | C—H | C—H | O | 1-cyanocyclopropyl |
| Ic-130 | CF2CF3 | CF3 | Me | H | H | H | C—H | C—Me | C—H | C—H | O | cyclopropyl |
| Ic-131 | CF2CF3 | CF3 | Me | H | H | H | C—H | C—Me | C—H | C—H | O | 4-fluorophenyl |
| Ic-132 | CF2CF3 | CF3 | Me | H | H | H | C—H | C—Cl | C—H | C—H | S | cyclopropyl |
| Ic-133 | CF3 | CHF2 | Me | H | H | H | C—H | C—Cl | C—H | C—H | O | cyclopropyl |
| Ic-134 | CF3 | S(O)Me | Me | H | H | H | C—H | C—Cl | C—H | C—H | O | 1-cyanocyclopropyl |
| Ic-135 | CF3 | CF3 | Me | H | H | H | C—H | C—Cl | C—H | C—H | O | phenyl |
| Ic-136 | CF2CF3 | CF3 | Me | H | H | H | C—H | C—Cl | C—H | C—H | O | phenyl |
| Ic-137 | CF2CF3 | CF3 | Me | H | H | H | C—H | C—Cl | C—H | C—H | O | 3-methylbutan-2-yl |
| Ic-138 | CF2CF3 | CF3 | Me | H | H | H | C—H | C—Cl | C—H | C—H | O | 2-(dimethylamino)ethyl |
| Ic-139 | CF2CF3 | CF3 | Me | H | H | H | C—H | C—Cl | C—H | C—H | O | 2-methoxyethyl |
| Ic-140 | CF2CF3 | CF3 | Me | H | H | H | C—H | C—Cl | C—H | C—H | O | pyridin-2-yl |
| Ic-141 | CF2CF3 | CF3 | Me | H | H | H | C—H | C—Cl | C—H | C—H | O | cyclopentyl |
| Ic-142 | CF2CF3 | CF3 | Me | H | H | H | C—H | C—Cl | C—H | C—H | O | isobutyl |
| Ic-143 | CF2CF3 | CF3 | Me | H | H | H | C—H | C—Cl | C—H | C—H | O | cyclobutyl |
| Ic-144 | CF2CF3 | CF3 | Me | H | H | H | C—H | C—Cl | C—H | C—H | O | 1H-tetrazol-5-yl |
| Ic-145 | CF2CF3 | CF3 | Me | H | H | H | C—H | C—Cl | C—H | C—H | O | 1,2-oxazol-3-yl |
| Ic-146 | CF2CF3 | CF3 | Me | H | H | H | C—H | C—Cl | C—H | C—H | O | 1H-imidazol-2-ylmethyl |
| Ic-147 | CF2CF3 | CF3 | Me | H | H | H | C—H | C—Cl | C—H | C—H | O | cyanomethyl |
| Ic-148 | CF2CF3 | CF3 | Me | H | H | H | C—H | C—Cl | C—H | C—H | O | 5-methyl-1,2-oxazol-3-yl |
| Ic-149 | CF2CF3 | CF3 | Me | H | H | H | C—H | C—Cl | C—H | C—H | O | pyridin-3-yl |
| Ic-150 | CF2CF3 | CF3 | Me | H | H | H | C—H | C—Cl | C—H | C—H | O | 1H-pyrazol-3-yl |
| Ic-151 | CF2CF3 | CF3 | Me | H | H | H | C—H | C—Cl | C—H | C—H | O | 3-chloropropyl |
| Ic-152 | CF2CF3 | CF3 | Me | H | H | H | C—H | C—Cl | C—H | C—H | O | methyl |
| Ic-153 | CF2CF3 | CF3 | Me | H | H | H | C—H | C—Cl | C—H | C—H | O | cyclopropylmethyl |
| Ic-154 | CF2CF3 | CF3 | Me | H | H | H | C—H | C—Cl | C—H | C—H | O | 1-amino-1-oxopropan-2-yl |
| Ic-155 | CF2CF3 | CF3 | Me | H | H | H | C—H | C—Cl | C—H | C—H | O | methoxy |
| Ic-156 | CF2CF3 | CF3 | Me | H | H | H | C—H | C—Cl | C—H | C—H | O | 2-amino-2-oxoethyl |
| Ic-157 | CF2CF3 | CF3 | Me | H | H | H | C—H | C—Cl | C—H | C—H | O | 1H-pyrazol-3-ylmethyl |
| Ic-158 | CF2CF3 | CF3 | Me | H | H | H | C—H | C—Cl | C—H | C—H | O | 5-methyl-1,3,4-oxadiazol- |
| | | | | | | | | | | | | 2-yl |
| Ic-159 | CF2CF3 | CF3 | Me | H | H | H | C—H | C—Cl | C—H | C—H | O | 1-methyl-1H-pyrazol-3-yl |
| Ic-160 | CF2CF3 | CF3 | Me | H | H | H | C—H | C—Cl | C—H | C—H | O | 4-methyl-1,3-oxazol-2-yl |
| Ic-161 | CF2CF3 | CF3 | Me | H | H | H | C—H | C—Cl | C—H | C—H | O | 1-cyclopropylpropan-2-yl |
| Ic-162 | CF2CF3 | CF3 | Me | H | H | H | C—H | C—Cl | C—H | C—H | O | 5-hydroxy-1H-pyrazol-3- |
| Ic-163 | CF2CF3 | CF3 | Me | H | H | H | C—H | C—Cl | C—H | C—H | O | 1-methyl-1H-pyrazol-5-yl |
| Ic-164 | CF2CF3 | CF3 | Me | H | H | H | C—H | C—Cl | C—H | C—H | O | (3R)-tetrahydrofuran-3-yl |
| Ic-165 | CF2CF3 | CF3 | Me | H | H | H | C—H | C—Cl | C—H | C—H | O | 1-methoxypropan-2-yl |
| Ic-166 | CF2CF3 | CF3 | Me | H | H | H | C—H | C—Cl | C—H | C—H | O | 1-methyl-1 H-pyrazol-4-yl |
| Ic-167 | CF2CF3 | CF3 | Me | H | H | H | C—H | C—Cl | C—H | C—H | O | 2-(methylsulfanyl)ethyl |
| Ic-168 | CF3 | CF3 | Me | H | H | H | C—H | C—Cl | C—H | C—H | O | 2-fluoroethyl |
| Ic-169 | CF3 | CF3 | Me | H | H | H | C—H | C—Cl | C—H | C—H | O | 2,2,2-trifluoroethyl |
| Ic-170 | CF3 | CF3 | Me | H | H | H | C—H | C—Cl | C—H | C—H | O | 2,2-difluoroethyl |
| Ic-171 | CF2CF3 | CF3 | Me | H | H | H | C—H | C—H | H | C-0- | O | cyclopropyl |
| | | | | | | | | | | CF2-0-C | | |
| Ic-172 | CF2CF3 | CF3 | Me | H | H | H | C—H | C—H | H | C-0- | O | 1-cyanocyclopropyl |
| | | | | | | | | | | CF2-0-C | | |
| Ic-173 | CF2CF3 | CF3 | Me | H | H | H | C—H | C—F | C- | C—H | O | cyclopropyl |
| | | | | | | | | | sulfamoyl | | | |
| Ic-174 | CF2CF3 | CF3 | Me | H | H | H | C—F | C—F | C—H | C—H | O | cyclopropyl |
| Ic-175 | CF2CF3 | CF3 | Me | H | H | H | C—F | C—F | C—H | C—H | O | 1-cyanocyclopropyl |
| Ic-176 | CF2CF3 | CF3 | Me | H | H | H | C—H | C—Cl | C—H | C—H | O | 1-ethoxycyclopropyl |
| Ic-177 | CF3 | CF3 | Me | H | H | H | C—H | C—Cl | C—H | C—H | O | 2-fluorocyclopropyl |
| Ic-178 | CF2CF3 | CF3 | Me | H | H | H | N | C—H | N | C—H | O | cyclopropyl |
| Ic-179 | CF2CF3 | CF3 | Me | H | H | H | N | C—H | N | C—H | O | 1-cyanocyclopropyl |
| Ic-180 | CF2CF3 | CF3 | Me | H | H | H | C—H | C—Cl | C—H | C—H | O | (1R,2R)-2- |
| | | | | | | | | | | | | ethoxycyclopropyl |
| Ic-181 | CF2CF3 | CF3 | Me | H | H | H | C—H | C—Cl | C—H | C—H | O | 2-(CF3)cyclopropyl |
| Ic-182 | CF2CF3 | CF3 | Me | H | H | H | C—H | C—SMe | C—H | C—H | O | cyclopropyl |
| Ic-183 | CF2CF3 | CF3 | Me | H | H | H | C—H | C—Cl | C—H | C—H | O | (1S,2S,3S)-2-ethoxy-3- |
| | | | | | | | | | | | | methylcyclopropyl |
| Ic-184 | CF2CF3 | CF3 | Me | H | H | H | C—H | C—Cl | C—H | C—H | O | 2,2-dichlorocyclopropyl |
| Ic-185 | CF2CF3 | CF3 | Me | H | H | H | C—H | C- | C—H | C—H | O | cyclopropyl |
| | | | | | | | | diethylsulfamoyl | | | | |
| Ic-186 | CF2CF3 | CF3 | Me | H | H | H | C—H | C—Cl | C—H | C—H | O | (1S,28)-2- |
| | | | | | | | | | | | | ethoxycyclopropyl |
| Ic-187 | CF2CF3 | CF3 | Me | H | H | H | C—H | C—Cl | C—H | C—H | O | 1-methoxycyclopropyl |
| Ic-188 | CF2CF3 | CF3 | Me | H | H | H | C—H | C—Cl | C—H | C—H | O | 1,1′-bi(cyclopropyl)-1-yl |
| Ic-189 | CF2CF3 | CF3 | Me | H | H | H | C—H | C—S(O)Me | C—H | C—H | O | cyclopropyl |
| Ic-190 | CF2CF3 | CF3 | Me | H | H | H | C—H | C—S(0)2Me | C—H | C—H | O | cyclopropyl |
| Ic-191 | CF2CF3 | CF3 | Me | H | H | amino | C—H | C—Cl | C—H | C—H | O | 1-cyanocyclopropyl |
| Ic-192 | CF2CF3 | CF3 | Me | H | H | amino | C—H | C—Cl | C—H | C—H | O | cyclopropyl |
| Ic-193 | CF2CF3 | CF3 | Me | H | H | H | C—H | C—Cl | C—H | C—H | O | but-3-yn-2-yl |
| Ic-194 | CF2CF3 | SMe | Me | H | H | H | C—H | C—Cl | C—H | C—H | O | 1-cyanocyclopropyl |
| Ic-195 | CF2CF3 | CF3 | Me | H | H | H | C—H | C—Cl | C- | C—H | O | cyclopropyl |
| | | | | | | | | | sulfamoyl | | | |
| Ic-196 | CF2CF3 | CF3 | Me | H | H | H | C—H | C—CF3 | C—H | C—H | O | cyclopropyl |
| Ic-197 | CF2CF3 | CF3 | Me | Et | H | H | C—H | C- | C—H | C—H | O | ethyl |
| | | | | | | | | cyclopropylsulfamoyl | | | | |
| Ic-198 | CF2CF3 | CF3 | Me | H | H | H | C—H | C—Cl | C—H | C—H | O | pent-3-yn-2-yl |
| Ic-199 | CF2CF3 | CF3 | Me | Me | H | H | C—H | C—Cl | C—H | C—H | O | cyclopropyl |
| Ic-200 | CF2CF3 | CF3 | Me | H | H | H | C—H | C—Cl | C—H | C—H | O | 1-methylcyclopropyl |
| Ic-201 | CF2CF3 | CF3 | Me | H | H | H | C—H | C—F | C—F | C—F | O | cyclopropyl |
| Ic-202 | CF2CF3 | CF3 | Me | H | H | H | C—H | C—F | C—F | C—F | O | 1-cyanocyclopropyl |
| Ic-203 | CF2CF3 | CF3 | Me | H | H | H | C—H | C—CF3 | C—H | C—H | O | 1-cyanocyclopropyl |
| Ic-204 | CF2CF3 | CF3 | Me | nPr | H | H | C—H | C—Cl | C—H | C—H | O | 1-cyanocyclopropyl |
| Ic-205 | CF2CF3 | CF3 | Me | propionyl | H | H | C—H | C—Cl | C—H | C—H | O | 1-cyanocyclopropyl |
| Ic-206 | CF2CF3 | CF3 | Me | allyl | H | H | C—H | C—Cl | C—H | C—H | O | 1-cyanocyclopropyl |
| Ic-207 | CF2CF3 | CF3 | Me | H | H | H | C—H | C—Cl | C—H | C—H | O | 1-cyclopropylethyl |
| Ic-208 | CF2CF3 | CF3 | Me | Et | H | H | C—H | C—Cl | C—H | C—H | O | 1-cyanocyclopropyl |
| Ic-209 | CF2CF3 | CF3 | Me | H | H | H | C—H | C—Cl | C—H | C—H | O | 4-fluorophenyl |
| Ic-210 | CF2CF3 | CF3 | Me | H | H | H | C—H | C—Cl | C—H | C—H | O | 1-cyclobutylcyclopropyl |
| Ic-211 | CF2CF3 | CF3 | Me | Et | H | H | C—H | C—Cl | C—H | C—H | O | cyclopropyl |
| Ic-212 | CF2CF3 | CF3 | Me | H | H | H | C—H | C—Cl | C—H | N | O | cyclopropyl |
| Ic-213 | CF2CF3 | CF3 | Me | H | H | H | C—H | C—Cl | C—H | N | O | 1-cyanocyclopropyl |
| Ic-214 | CF2CF3 | CF3 | Me | H | H | H | C—H | C—Cl | C—H | C—H | O | pyrazin-2-yl |

or an agrochemically acceptable salt or N-oxide thereof. [symbol]
indicates data missing or illegible when filed

or an agrochemically acceptable salt or N-oxide thereof.

Embodiment 6: A method according to embodiment 1, wherein the compound is selected from

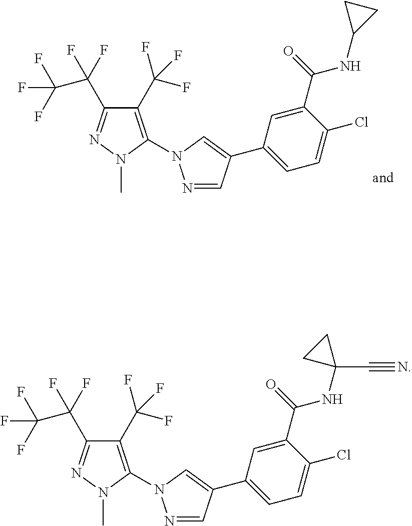 [SMILES: Cn1nc(C(F)(F)C(F)(F)F)c(C(F)(F)F)c1-n1cc(-c2ccc(Cl)c(C(=O)NC3CC3)c2)cn1 ; Cn1nc(C(F)(F)C(F)(F)F)c(C(F)(F)F)c1-n1cc(-c2ccc(Cl)c(C(=O)NC3(C#N)CC3)c2)cn1]

Embodiment 7: Use of a compound as defined in any one of embodiments 1 to 6 for controlling and/or preventing infestation of stinkbugs.

Embodiment 8: The method according to any one of embodiments 1 to 6 or the use according to embodiment 7, wherein the stinkbug is selected from Nezara spp. (e.g. Nezara viridula, Nezara antennata, Nezara hilare), Piezodorus spp. (e.g. Piezodorus guildinii), Acrosternum spp. (e.g. Acrosternum hilare), Euchistus spp. (e.g. Euchistus heros, Euschistus servus), Halymorpha spp. (e.g. Halyomorpha halys), Plautia crossota, Riptortus clavatus, Rhopalus msculatus, Antestiopsis spp. (e.g. Antestiopsis orbitalus), Dichelops spp. (e.g. Dichelops furcatus, Dichelops melacanthus), Edessa spp. (e.g. Edessa meditabunda), Eurygaster spp. (e.g. Eurygaster intergriceps, Eurygaster maura), Murgantia spp., Oebalus spp. (e.g. Oebalus mexicana, Oebalus poecilus, Oebalus pugnase, Oebalus pugnax), Thianta spp., Pentatomidae, Lygus spp. (e.g. Lygus lineolaris, Lygus hesperus, Lygus elisus), Thyanta spp., Tibraca spp. and Scotinophara spp. (e.g. Scotinophara lurida, Scotinophara coarctata).

Embodiment 9: The method according to any one of embodiments 1 to 6 or the use according to embodiment 7, wherein the stinkbug is selected from the genus Euschistus.

Embodiment 10: The method according to any one of embodiments 1 to 6 or the use according to embodiment 7, wherein the stinkbug is Euschistus heros.

Embodiment 11: The method or the use according to any one of embodiments 1 to 6 or the use according to embodiment 7, wherein the method or use is for controlling stinkbugs that are resistant to one or more other insecticides.

Embodiment 12: The method or use according to embodiment 11, wherein the stinkbugs that are resistant to one or more other insecticides are resistant to pyrethroid, neonicotinoids and/or organophosphates, more preferably pyrethroid insecticides.

Embodiment 13: A method for obtaining regulatory approval for the use of a compound as defined in any one of embodiments 1 to 6 for controlling and/or preventing infestation of stinkbugs, particularly Euschistus spp., comprising at least one step of referring to, submitting or relying on biological data showing that said active ingredient reduces stinkbug pressure.

Embodiment 13.1: A method for growing soybean comprising applying or treating soybean or a seed thereof with a compound as defined in any one embodiments 1 to 6.

Embodiment 13.2: The method according to any one of embodiments 1 to 13 or the use according to any one of embodiment 7 to 13, wherein the plant is selected from soybean, sorghum, sunflower, sugarbeet, cereals, coffee, cocoa, corn, cotton, citrus fruits, grapes, potato, rice, sugarcane and vegetables.

Embodiment 13.3: The method according to any one of embodiments 1 to 13 or the use according to any one of embodiment 7 to 13, wherein the plant is selected from soybean, sorghum, sunflower, cereals, corn and cotton.

Embodiment 13.4: The method according to any one of embodiments 1 to 13 or the use according to any one of embodiment 7 to 13, wherein the plant is selected from soybean and sunflower, in particular soybean.

As used herein, when one embodiment refers to several other embodiments by using the term “according to any one of”, for example “according to any one of embodiments 1 to 13”, then said embodiment refers not only to embodiments indicated by the integers such as 1 and 2 but also to embodiments indicated by numbers with a decimal component such as 13.1.

The compounds as defined in any one of embodiments 1 to 6 may exist in different geometric or optical isomers or tautomeric forms. This invention covers all such isomers and tautomers and mixtures thereof in all proportions as well as isotopic forms such as deuterated compounds. The invention also covers salts and N-oxides of the compounds of the invention.

The preparation of the compounds as defined in any one of embodiments 1 to 6 has been disclosed in WO 2014/122083 which is incorporated herein by reference.

Definitions:

The term “Alkyl” as used herein—in isolation or as part of a chemical group—represents straight-chain or branched hydrocarbons, preferably with 1 bis 6 carbon atoms, for example methyl, ethyl, n-propyl, isopropyl, n-butyl, isobutyl, s-butyl, t-butyl, pentyl, 1-methylbutyl, 2-methylbutyl, 3-methylbutyl, 1,2-dimethylpropyl, 1,1-dimethylpropyl, 2,2-dimethylpropyl, 1-ethylpropyl, hexyl, 1-methylpentyl, 2-methylpentyl, 3-methylpentyl, 4-methylpentyl, 1,2-dimethylpropyl, 1,3-dimethylbutyl, 1,4-dimethylbutyl, 2,3-dimethylbutyl, 1,1-dimethylbutyl, 2,2-dimethylbutyl, 3,3-dimethylbutyl, 1,1,2-trimethylpropyl, 1,2,2-trimethylpropyl, 1-ethylbutyl and 2-ethylbutyl. Alkyls groups with 1 to 4 carbon atoms are preferred, for example methyl, ethyl, n-propyl, isopropyl, n-butyl, isobutyl, s-butyl or t-butyl.

The term “Alkenyl”—in isolation or as part of a chemical group—represents straight-chain or branched hydrocarbons, preferably with 2 bis 6 carbon atoms and at least one double bond, for example vinyl, 2-propenyl, 2-butenyl, 3-butenyl, 1-methyl-2-propenyl, 2-methyl-2-propenyl, 2-pentenyl, 3-pentenyl, 4-pentenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-2-propenyl, 1-ethyl-2-propenyl, 2-hexenyl, 3-hexenyl, 4-hexenyl, 5-hexenyl, 1-methyl-2-pentenyl, 2-methyl-2-pentenyl, 3-methyl-2-pentenyl, 4-methyl-2-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-2-butenyl, l,2-dimethyl-3-butenyl, 1,3-dimethyl-2-butenyl, 2,2-dimethyl-3-butenyl, 2,3-dimethyl-2-butenyl, 2,3-dimethyl-3-butenyl, 1-ethyl-2-butenyl, 1-ethyl-3-butenyl, 2-ethyl-2-butenyl, 2-ethyl-3-butenyl, 1,1,2-trimethyl-2-propenyl, 1-ethyl-1-methyl-2-propenyl und 1-ethyl-2-methyl-2-propenyl. Alkenyl groups with 2 to 4 carbon atoms are preferred, for example 2-propenyl, 2-butenyl or 1-methyl-2-propenyl.

The term “Alkinyl”—in isolation or as part of a chemical group—represents straight-chain or branched hydrocarbons, preferably with 2 bis 6 carbon atoms and at least one triple bond, for example 2-propinyl, 2-butinyl, 3-butinyl, 1-methyl-2-propinyl, 2-pentinyl, 3-pentinyl, 4-pentinyl, 1-methyl-3-butinyl, 2-methyl-3-butinyl, 1-methyl-2-butinyl, 1,1-dimethyl-2-propinyl, 1-ethyl-2-propinyl, 2-hexinyl, 3-hexinyl, 4-hexinyl, 5-hexinyl, 1-methyl-2-pentinyl, 1-methyl-3-pentinyl, 1-methyl-4-pentinyl, 2-methyl-3-pentinyl, 2-methyl-4-pentinyl, 3-methyl-4-pentinyl, 4-methyl-2-pentinyl, 1,1-dimethyl-3-butinyl, 1,2-dimethyl-3-butinyl, 2,2-dimethyl-3-butinyl, 1-ethyl-3-butinyl, 2-ethyl-3-butinyl, 1-ethyl-1-methyl, 1,2-propinyl and 2,5-hexadiynyl.

Alkinyls with 2 to 4 carbon atoms are preferred, for example ethinyl, 2-propinyl or 2-butinyl-2-propenyl.

The term “cycloalkyl”—in isolation or as part of a chemical group—represents mono-, bi- or tricyclic hydrocarbons, preferably 3 to 10 carbon atoms, for example cyclopropyl, cyclobutyl, cyclopentyl, cyclohexyl, cycloheptyl, cyclooctyl, bicyclo[2.2.1]heptyl, bicyclo[2.2.2]octyl or adamantyl.

Cycloalkyls with 3, 4, 5, 6 or 7 carbon atoms are preferred, for example cyclopropyl or cyclobutyl.

The term “heterocycloalkyl”—in isolation or as part of a chemical group—represents mono-, bi- or tricyclic hydrocarbons, preferably 3 to 10 carbon atoms, for example cyclopropyl, cyclobutyl, cyclopentyl, cyclohexyl, cycloheptyl, cyclooctyl, bicyclo[2.2.1]heptyl, bicyclo[2.2.2]octyl or adamantyl, wherein one or more of the ring atoms, preferably 1 to 4, more preferably 1, 2 or 3 of the ring atoms are independently selected from N, O, S, P, B, Si and Se, more preferably N, O and S, wherein no O atoms can be located next to each other. The term “Alkylcycloalkyl” represents mono-, bi-oder tricyclic alkylcycloalkyl, preferably with 4 to 10 or 4 to 7 carbon atoms, for example ethylcyclopropyl, isopropylcyclobutyl, 3-methylcyclopentyl und 4-methyl-cyclohexyl.

Alkylcycloalkyls with 4, 5 or 7 carbon atoms are preferred, for example ethylcyclopropyl or 4-methyl-cyclohexyl.

The term “cycloalkylalkyl” represents mono, bi- or tricyclic cycloalkylalkyls, preferably 4 to 10 or 4 to 7 carbon atoms, for example cyclopropylmethyl, cyclobutylmethyl, cyclopentylmethyl, cyclohexylmethyl and cyclopentylethyl.

Cycloalkylalkyls with 4, 5 or 7 carbon atoms are preferred, for example cyclopropylmethyl or cyclobutylmethyl.

The term “halogen” represents fluoro, chloro, bromo or iodo, particularly fluoro, chloro or bromo.

The chemical groups which are substituted with halogen, for example halogenalkyl, halogencycloalkyl, halogenalkyloxy, halogenalkylsulfanyl, halogenalkylsulfinyl or halogenalkylsulfonyl are substituted one or up to the maximum number of substituents with halogen.

If “alkyl”, “alkenyl” or “alkinyl” are substituted with halogen, the halogen atoms can be the same or different and can be bound at the same carbon atom or different carbon atoms.

The term “halogencycloalkyl” represents mono-, bi- or tricyclic halogencycloalkyl, preferably with 3 to 10 carbon atoms, for example 1-fluoro-cyclopropyl, 2-fluoro-cyclopropyl or 1-fluoro-cyclobutyl. Preferred halogencycloalkyl mit 3, 5 oder 7 carbon atoms.

The term “halogenalkyl”, “halogenalkenyl” or “halogenalkinyl” represents alkyls, alkenyls or alkinyls substituted with halogen, preferably with 1 to 9 halogen atoms that are the same or different, for example monohaloalkyls (=monohalogenalkyl) like CH₂CH₂Cl, CH₂CH₂F, CHClCH₃, CHFCH₃, CH₂Cl, CH₂F; perhaloalkyls like CCl₃ or CF₃ or CF₂CF₃; polyhaloalkyls like CHF₂, CH₂F, CH₂CHFCl, CF₂CF₂H, CH₂CF₃.

The same applies for haloalkenyl and other groups substituted by halogen.

Examples of haloalkoxy are for example OCF₃, OCHF₂, OCH₂F, OCF₂CF₃, OCH₂CF₃, OCF₃, OCHF₂, OCH₂F, OCF₂CF₃, OCH₂CF₃.

Further examples of halogenalkyls are trichloromethyl, chlorodifluoromethyl, dichlorofluoromethyl, 1-fluoroethyl, 2-fluoroethyl, 2,2-difluoroethyl, 2,2,2-trifluorethyl, 2,2,2-trichloroethyl, 2-chloro-2,2-difluoroethyl, pentafluorethyl and pentafluoro-t-butyl. Halogenalkyls having 1 to 4 carbon atoms and 1 to 9, preferably 1 to 5 of the same or different halogen atoms selected from fluoro, chloro or bromo, are preferred. Halogenalkyls having 1 or 2 carbon atoms and 1 to 5 gleichen of the same or different halogen atoms selected from fluoro or chloro, for example difluoromethyl, trifluoromethyl or 2,2-difluoroethyl, are particularly preferred.

The term “hydroxyalkyl” represents straight or branched chain alcohols, preferably with 1 to 6 carbon atoms, for example methanol, ethanol, n-propanol, isopropanol, n-butanol, isobutanol, s-butanol and t-butanol.

Hydroxyalkyls having 1 to 4 carbon atoms are preferred.

The term “alkoxy” represents straight or branched chain O-alkyl, preferably having 1 to 6 carbon atoms, for example methoxy, ethoxy, n-propoxy, isopropoxy, n-butoxy, isobutoxy, s-butoxy und t-butoxy.

Alkoxy having 1 to 4 carbon atoms are preferred.

The term “halogenalkoxy” represents straight or branched chain O-alkyl substituted with halogen, preferably with 1 to 6 carbon atoms, for example difluoromethoxy, trifluoromethoxy, 2,2-difluoroethoxy, 1,1,2,2-tetrafluoroethoxy, 2,2,2-Trifluoroethoxy and 2-Chloro-1,1,2-trifluorethoxy.

Halogenalkoxy having 1 to 4 carbon atoms are preferred.

The term “alkylsulfanyl” represents straight or branched chain s-alkyl, preferably with 1 to 6 carbon atoms, for example methylthio, ethylthio, n-propylthio, isopropylthio, n-butylthio, isobutylthio, s-butylthio and t-butylthio.

Alkylsulfanyl having 1 to 4 carbon atoms are preferred.

Examples for halogenalkylsulfanyl, i.e. with halogen substituted alkylsulfanyl, are for example difluoromethylthio, trifluoromethylthio, trichloromethylthio, chlorodifluormethylthio, 1-fluoroethylthio, 2-fluoroethylthio, 2,2-difluoroethylthio, 1,1,2,2-tetrafluoroethylthio, 2,2,2-trifluoroethylthio or 2-chloro-1,1,2-trifluoroethylthio.

The term “alkylsulfinyl” represents straight or branched chain alkylsulfinyl, preferably having 1 to 6 carbon atoms, for example methylsulfinyl, ethylsulfinyl, n-propylsulfinyl, isopropylsulfinyl, n-butylsulfinyl, isobutylsulfinyl, s-butylsulfinyl und t-Bbylsulfinyl.

Alkylsulfinyls having 1 to 4 carbon atoms are preferred.

Examples of halogenalkylsulfinyls, i.e. with halogen substituted alkylsulfinyls, are difluoromethylsulfinyl, trifluoromethylsulfinyl, trichloromethylsulfinyl, chlorodifluoromethylsulfinyl, 1-fluoroethylsulfinyl, 2-fluoroethylsulfinyl, 2,2-difluoroethylsulfinyl, 1,1,2,2-tetrafluoroethylsulfinyl, 2,2,2-trifluoroethylsulfinyl and 2-chloro-1,1,2-trifluoroethylsulfinyl.

The term “alkylsulfonyl” represents straight or branched chain alkylsulfonyl, preferably having 1 to 6 carbon atoms, for example methylsulfonyl, ethylsulfonyl, n-propylsulfonyl, isopropylsulfonyl, n-butylsulfonyl, isobutylsulfonyl, s-butylsulfonyl and t-butylsulfonyl.

Alkylsulfonyls having 1 to 4 carbon atoms are preferred.

Examples of halogenalkylsulfonyls, i.e. with halogen substituted alkylsulfonyls, are for example difluoromethylsulfonyl, trifluoromethylsulfonyl, trichloromethylsulfonyl, chlorodifluoromethylsulfonyl, 1-fluoroethylsulfonyl, 2-fluoroethylsulfonyl, 2,2-difluoroethylsulfonyl, 1,1,2,2-tetrafluoroethylsulfonyl, 2,2,2-trifluoroethylsulfonyl and 2-chloro-1,1,2-trifluorethylsulfonyl.

The term “alkylcarbonyl” represents straight or branched chain alkyl-C(═O), preferably having 2 to 7 carbon atoms, for example methylcarbonyl, ethylcarbonyl, n-propylcarbonyl, isopropylcarbonyl, s-butylcarbonyl and t-butylcarbonyl.

Alkylcarbonyls having 1 to 4 carbon atoms are preferred.

The term “cycloalkylcarbonyl” represents cycloalkyl-carbonyl, preferably 3 to 10 carbon atoms in the cycloalkyl part, for example cyclopropylcarbonyl, cyclobutylcarbonyl, cyclopentylcarbonyl, cyclohexyl-carbonyl, cycloheptyl-carbonyl, cyclooctylcarbonyl, bicyclo[2.2.1]heptyl, bycyclo[2.2.2]octylcarbonyl and adamantylcarbonyl.

Cycloalkylcarbonyls having 3, 5 or 7 carbon atoms in the cycloalkyl part are preferred.

The term “alkoxycarbonyl” ”—in isolation or as part of a chemical group—represents straight or branched chain alkoxycarbonyl, preferably having 1 to 6 carbon atoms or 1 to 4 carbon atoms in the alkoxy part, for example methoxycarbonyl, ethoxycarbonyl, n-propoxycarbonyl, isopropoxycarbonyl, s-butoxycarbonyl and t-butoxycarbonyl.

The term “alkylaminocarbonyl” represents straight or branched chain alkylaminocarbonyl having preferably 1 to 6 carbon atoms or 1 to 4 carbon atoms in the alkyl part, for example methylaminocarbonyl, ethylaminocarbonyl, n-proylaminocarbonyl, isopropyl-aminocarbonyl, s-butylaminocarbonyl and t-butylaminocarbonyl.

The term “N,N-Dialkylamino-carbonyl” ” represents straight or branched chain N,N-dialkylaminocarbonyl with preferably 1 to 6 carbon atoms or 1 to 4 carbon atoms in the alkyl part, for example N,N-Dimethylamino-carbonyl, N,N-diethylamino-carbonyl, N,N-di(n-propylamino)-carbonyl, N,N-di-(isopropylamino)-carbonyl and N,N-di-(s-butylamino)-carbonyl.

The term “aryl” represents a mono-, bi- or polycyclical aromatic system with preferably 6 to 14, more preferably 6 to 10 ring-carbon atoms, for example phenyl, naphthyl, anthryl, phenanthrenyl, preferably phenyl. “Aryl” also represents polycyclic systems, for example tetrahydronaphtyl, indenyl, indanyl, fluorenyl, biphenyl.

Arylalkyls are examples of substituted aryls, which may be further substituted with the same or different substituents both at the aryl or alkyl part.

Benzyl and 1-phenylethyl are examples of such arylalkyls.

The term “heterocyclyl”, “heterocyclic ring” or “heterocyclic ring system” represents a carbocyclic ring system with at least one ring, in which ring at least one carbon atom is replaced by a heteroatom, preferably selected from N, O, S, P, B, Si, Se, and which ring is saturated, unsaturated or partially saturated, and which ring is unsubstituted or substituted with a substituent Z, wherein the connecting bond is located at a ring atom.

Unless otherwise defined, the heterocyclic ring has preferably 3 to 9 ring atoms, preferably 3 to 6 ring atoms, and one or more, preferably 1 to 4, more preferably 1, 2 or 3 heteroatoms in the heterocyclic ring, preferably selected from N, O, and S, wherein no O atoms can be located next to each other.

The heterocyclic rings normally contain no more than 4 nitrogens, and/or no more than 2 oxygen atoms and/or no more than 2 sulfur atoms.

In case that the heterocyclic substituent or the heterocyclic ring are further substituted, it can be further annulated with other heterocyclic rings.

The term “heterocyclic” also includes polycyclic systems, for example 8-aza-bicyclo[3.2.1]octanyl or 1-aza-bicyclo[2.2.1]heptyl.

The term “heterocyclic” also includes spirocyclic systems, for example 1-oxa-5-aza-spiro[2.3]hexyl.

Examples of heterocyclyls are for example piperidinyl, piperazinyl, morpholinyl, thiomorpholinyl, dihydropyranyl, tetrahydropyranyl, dioxanyl, pyrrolinyl, pyrrolidinyl, imidazolinyl, imidazolidinyl, thiazolidinyl, oxazolidinyl, dioxolanyl, dioxolyl, pyrazolidinyl, tetrahydrofuranyl, dihydrofuranyl, oxetanyl, oxiranyl, azetidinyl, aziridinyl, oxazetidinyl, oxaziridinyl, oxazepanyl, oxazinanyl, azepanyl, oxopyrrolidinyl, dioxopyrrolidinyl, oxomorpholinyl, oxopiperazinyl und oxepanyl.

Particularly important are heteroaryls, i.e. heteroaromatic systems.

The term “heteroaryl” represents heteroaromatic groups, i.e. completely unsaturated aromatic heterocyclic groups, which fall under the above definition of heterocycls. “Heteroaryls” with 5 to 7-membered rings with 1 to 3, preferably 1 or 2 of the same or different heteroatoms selected from N, O, and S.

Examples of “heteroaryls” are furyl, thienyl, pyrazolyl, imidazolyl, 1,2,3- and 1,2,4-triazolyl, isoxazolyl, thiazolyl, isothiazolyl, 1,2,3-, 1,3,4-, 1,2,4- and 1,2,5-oxadiazolyl, azepinyl, pyrrolyl, pyridyl, pyridazinyl, pyrimidinyl, pyrazinyl, 1,3,5-, 1,2,4- and 1,2,3-triazinyl, 1,2,4-, 1,3,2-, 1,3,6- and 1,2,6-oxazinyl, oxepinyl, thiepinyl, 1,2,4-triazolonyl und 1,2,4-diazepinyl.

The methods and uses according to any one of embodiments 1 to 13 are preferably for controlling and/or preventing infestation of the crop by stinkbugs, including stinkbugs that are resistant to other insecticides, e.g. pyrethroid insecticides. Stinkbugs that are “resistant” to a particular insecticide refers e.g. to strains of stinkbugs that are less sensitive to that insecticide compared to the expected sensitivity of the same species of stinkbug. The expected sensitivity can be measured using e.g. a strain that has not previously been exposed to the insecticide.

Application is of the compounds as defined in any one of embodiments 1 to 6 is preferably to a crop of plants, the locus thereof or propagation material thereof. Preferably application is to a crop of plants or the locus thereof, more preferably to a crop of plants. Application may be before infestation or when the pest is present. Application of the compounds of the invention can be performed according to any of the usual modes of application, e.g. foliar, drench, soil, in furrow etc. However, control of stinkbugs is usually achieved by foliar application, which is the preferred mode of application according to the invention.

The compounds as defined in any one of embodiments 1 to 6 may be applied in combination with an attractant. An attractant is a chemical that causes the insect to migrate towards the location of application. For control of stinkbugs it can be advantageous to apply the compounds of the invention with an attractant, particularly when the application is foliar. Stinkbugs are often located near to the ground, and application of an attractant may encourage migration up the plant towards the active ingredient. Suitable attractants include glucose, sacchrose, salt, glutamate (e.g. Aji-no-moto™), citric acid (e.g. Orobor™), soybean oil, peanut oil and soybean milk. Glutamate and citric acid are of particular interest, with citric acid being preferred.

An attractant may be premixed with the compound as defined in any one of embodiments 1 to 6 prior to application, e.g. as a readymix or tankmix, or by simultaneous application or sequential application to the plant. Suitable rates of attractants are for example 0.02 kg/ha-3 kg/ha.

The compounds as defined in any one of embodiments 1 to 6 are preferably used for pest control at 1 to 500 g/ha, preferably 10-70 g/ha.

The compounds as defined in any one of embodiments 1 to 6 are suitable for use on any plant, including those that have been genetically modified to be resistant to active ingredients such as herbicides, or to produce biologically active compounds that control infestation by plant pests.

In a further embodiment 14, transgenic plants and plant cultivars obtained by genetic engineering methods, if appropriate in combination with conventional methods (Genetically Modified Organisms), and parts thereof, are treated. Particularly preferably, plants of the plant cultivars which are in each case commercially available or in use are treated according to the invention. Plant cultivars are understood as meaning plants having novel properties (“traits”) which have been obtained by conventional breeding, by mutagenesis or by recombinant DNA techniques. These can be cultivars, bio- or genotypes. Depending on the plant species or plant cultivars, their location and growth conditions (soils, climate, vegetation period, diet), the treatment according to the invention may also result in superadditive “synergistic”) effects. Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products are possible, which exceed the effects which were actually to be expected.

The preferred transgenic plants or plant cultivars (obtained by genetic engineering) which are to be treated according to the invention include all plants which, by virtue of the genetic modification, received genetic material which imparts particularly advantageous, useful traits to these plants. Examples of such traits are better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products. Further and particularly emphasized examples of such traits are a better defence of the plants against animal and microbial pests, such as against insects, mites, phytopathogenic fungi, bacteria and/or viruses, and also increased tolerance of the plants to certain herbicidally active compounds.

Traits that are emphasized in particular are the increased defence of the plants against insects, arachnids, nematodes and slugs and snails by virtue of toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (referred to herein as “Bt plants”). Traits that are also particularly emphasized are the increased defence of the plants against fungi, bacteria and viruses by systemic acquired resistance (SAR), systemin, phytoalexins, elicitors and resistance genes and correspondingly expressed proteins and toxins. Traits that are furthermore particularly emphasized are the increased tolerance of the plants to certain herbicidally active compounds, for example imidazolinones, sulphonylureas, glyphosate or phosphinotricin (for example the “PAT” gene). The genes which impart the desired traits in question can also be present in combination with one another in the transgenic plants. Examples of “Bt plants” are soya bean varieties which are sold under the trade names YIELD CARD(®)

Examples of herbicide-tolerant plants which may be mentioned are soybean varieties which are sold under the trade names Roundup Ready(®) (tolerance to glyphosate), Liberty Link(®) (tolerance to phosphinotricin), IMI(®) (tolerance to imidazolinones) and STS(®) (tolerance to sulphonylureas). Herbicide-resistant plants (plants bred in a conventional manner for herbicide tolerance) which may be mentioned include the varieties sold under the name Clearfield(®) (for example maize).

Of particular interest are soybean plants carrying traits conferring resistance to 2.4D (e.g. Enlist®), glyphosate (e.g. Roundup Ready®, Roundup Ready 2 Yield®), sulfonylurea (e.g. STS®), glufosinate (e.g. Liberty Link®, Ignite®), Dicamba (Monsanto) HPPD tolerance (e.g. isoxaflutole herbicide) (Bayer CropScience, Syngenta). Double or triple stack in soybean plants of any of the traits described here are also of interest, including glyphosate and sulfonyl-urea tolerance (e.g. Optimum GAT®, plants stacked with STS® and Roundup Ready® or Roundup Ready 2 Yield®), dicamba and glyphosate tolerance (Monsanto). Soybean Cyst Nematode resistance soybean (SCN®-Syngenta) and soybean with Aphid resistant trait (AMT®-Syngneta) are also of interest.

These statements also apply to plant cultivars having these genetic traits or genetic traits still to be developed, which plant cultivars will be developed and/or marketed in the future.

The compounds as defined in any one of embodiments 1 to 6 are preferably used to control stinkbugs, e.g. selected from Nezara spp. (e.g. Nezara viridula, Nezara antennata, Nezara hilare), Piezodorus spp. (e.g. Piezodorus guildinii), Acrosternum spp. (e.g. Acrosternum hilare), Euchistus spp. (e.g. Euchistus heros, Euschistus servus), Halymorpha spp. (e.g. Halyomorpha halys), Plautia crossota, Riptortus clavatus, Rhopalus msculatus, Antestiopsis spp. (e.g. Antestiopsis orbitalus), Dichelops spp. (e.g. Dichelops furcatus, Dichelops melacanthus), Edessa spp. (e.g. Edessa meditabunda), Eurygaster spp. (e.g. Eurygaster intergriceps, Eurygaster maura), Murgantia spp., Oebalus spp. (e.g. Oebalus mexicana, Oebalus poecilus, Oebalus pugnase, Oebalus pugnax), Thianta spp., Pentatomidae, Lygus spp. (e.g. Lygus lineolaris, Lygus hesperus, Lygus elisus), Thyanta spp., Tibraca spp. and Scotinophara spp. (e.g. Scotinophara lurida, Scotinophara coarctata).

The compounds as defined in any one of embodiment 1 to 6 are particularly effective against Euschistus and in particular Euchistus heros. Euschistus and in particular Euchistus heros are the preferred targets.

In order to apply compounds as defined in any one of embodiments 1 to 6 in a method according to any one of embodiments 1 to 13, the compounds are usually formulated into a composition which includes, in addition to the compound as defined in any one of embodiment 1 to 6, a suitable inert diluent or carrier and, optionally, a surface active agent (SFA). SFAs are chemicals which are able to modify the properties of an interface (for example, liquid/solid, liquid/air or liquid/liquid interfaces) by lowering the interfacial tension and thereby leading to changes in other properties (for example dispersion, emulsification and wetting). It is preferred that all compositions (both solid and liquid formulations) comprise, by weight, 0.0001 to 95%, more preferably 1 to 85%, for example 5 to 60%, of a compound as defined in any one of embodiments 1 to 6. The composition is generally used for the control of pests such that a compound as defined in any one of embodiments 1 to 6 is applied at a rate of from 0.1 g to10 kg per hectare, preferably from 1 g to 6 kg per hectare, more preferably from 1 g to 1 kg per hectare.

When used in a seed dressing, a compound as defined in any one of embodiments 1 to 6 is used at a rate of 0.0001 g to 10 g (for example 0.001 g or 0.05 g), preferably 0.005 g to 10 g, more preferably 0.005 g to 4 g, per kilogram of seed.

Compositions comprising a compound as defined in any one of embodiments 1 to 6 can be chosen from a number of formulation types, including dustable powders (DP), soluble powders (SP), water soluble granules (SG), water dispersible granules (WG), wettable powders (WP), granules (GR) (slow or fast release), soluble concentrates (SL), oil miscible liquids (OL), ultra low volume liquids (UL), emulsifiable concentrates (EC), dispersible concentrates (DC), emulsions (both oil in water (EW) and water in oil (EO)), micro-emulsions (ME), suspension concentrates (SC), aerosols, fogging/smoke formulations, capsule suspensions (CS) and seed treatment formulations. The formulation type chosen in any instance will depend upon the particular purpose envisaged and the physical, chemical and biological properties of the compound as defined in any one of embodiments 1 to 6.

Dustable powders (DP) may be prepared by mixing a compound as defined in any one of embodiments 1 to 6 with one or more solid diluents (for example natural clays, kaolin, pyrophyllite, bentonite, alumina, montmorillonite, kieselguhr, chalk, diatomaceous earths, calcium phosphates, calcium and magnesium carbonates, sulfur, lime, flours, talc and other organic and inorganic solid carriers) and mechanically grinding the mixture to a fine powder. Soluble powders (SP) may be prepared by mixing a compound as defined in any one of embodiments 1 to 6 with one or more water-soluble inorganic salts (such as sodium bicarbonate, sodium carbonate or magnesium sulfate) or one or more water-soluble organic solids (such as a polysaccharide) and, optionally, one or more wetting agents, one or more dispersing agents or a mixture of said agents to improve water dispersibility/solubility. The mixture is then ground to a fine powder. Similar compositions may also be granulated to form water soluble granules (SG). Wettable powders (WP) may be prepared by mixing a compound as defined in any one of embodiments 1 to 6 with one or more solid diluents or carriers, one or more wetting agents and, preferably, one or more dispersing agents and, optionally, one or more suspending agents to facilitate the dispersion in liquids. The mixture is then ground to a fine powder. Similar compositions may also be granulated to form water dispersible granules (WG). Granules (GR) may be formed either by granulating a mixture of a compound as defined in any one of embodiments 1 to 6 and one or more powdered solid diluents or carriers, or from pre-formed blank granules by absorbing a compound as defined in any one of embodiments 1 to 6 (or a solution thereof, in a suitable agent) in a porous granular material (such as pumice, attapulgite clays, fuller's earth, kieselguhr, diatomaceous earths or ground corn cobs) or by adsorbing a compound as defined in any one of embodiments 1 to 6 (or a solution thereof, in a suitable agent) on to a hard core material (such as sands, silicates, mineral carbonates, sulfates or phosphates) and drying if necessary. Agents which are commonly used to aid absorption or adsorption include solvents (such as aliphatic and aromatic petroleum solvents, alcohols, ethers, ketones and esters) and sticking agents (such as polyvinyl acetates, polyvinyl alcohols, dextrins, sugars and vegetable oils). One or more other additives may also be included in granules (for example an emulsifying agent, wetting agent or dispersing agent). Dispersible Concentrates (DC) may be prepared by dissolving a compound as defined in any one of embodiments 1 to 6 in water or an organic solvent, such as a ketone, alcohol or glycol ether. These solutions may contain a surface active agent (for example to improve water dilution or prevent crystallization in a spray tank). Emulsifiable concentrates (EC) or oil-in-water emulsions (EW) may be prepared by dissolving a compound as defined in any one of embodiments 1 to 6 in an organic solvent (optionally containing one or more wetting agents, one or more emulsifying agents or a mixture of said agents). Suitable organic solvents for use in ECs include aromatic hydrocarbons (such as alkylbenzenes or alkylnaphthalenes, exemplified by SOLVESSO 100, SOLVESSO 150 and SOLVESSO 200; SOLVESSO is a Registered Trade Mark), ketones (such as cyclohexanone or methylcyclohexanone) and alcohols (such as benzyl alcohol, furfuryl alcohol or butanol), N-alkylpyrrolidones (such as N-methylpyrrolidone or N-octylpyrrolidone), dimethyl amides of fatty acids (such as C₈-C₁₀ fatty acid dimethylamide) and chlorinated hydrocarbons. An EC product may spontaneously emulsify on addition to water, to produce an emulsion with sufficient stability to allow spray application through appropriate equipment. Preparation of an EW involves obtaining a compound as defined in any one of embodiments 1 to 6 either as a liquid (if it is not a liquid at room temperature, it may be melted at a reasonable temperature, typically below 70° C.) or in solution (by dissolving it in an appropriate solvent) and then emulsifiying the resultant liquid or solution into water containing one or more SFAs, under high shear, to produce an emulsion. Suitable solvents for use in EWs include vegetable oils, chlorinated hydrocarbons (such as chlorobenzenes), aromatic solvents (such as alkylbenzenes or alkylnaphthalenes) and other appropriate organic solvents which have a low solubility in water. Microemulsions (ME) may be prepared by mixing water with a blend of one or more solvents with one or more SFAs, to produce spontaneously a thermodynamically stable isotropic liquid formulation. A compound as defined in any one of embodiments 1 to 6 is present initially in either the water or the solvent/SFA blend. Suitable solvents for use in MEs include those hereinbefore described for use in ECs or in EWs. An ME may be either an oil-in-water or a water-in-oil system (which system is present may be determined by conductivity measurements) and may be suitable for mixing water-soluble and oil-soluble pesticides in the same formulation. An ME is suitable for dilution into water, either remaining as a microemulsion or forming a conventional oil-in-water emulsion. Suspension concentrates (SC) may comprise aqueous or non-aqueous suspensions of finely divided insoluble solid particles of a compound as defined in any one of embodiments 1 to 6. SCs may be prepared by ball or bead milling the solid compound as defined in any one of embodiments 1 to 6 in a suitable medium, optionally with one or more dispersing agents, to produce a fine particle suspension of the compound. One or more wetting agents may be included in the composition and a suspending agent may be included to reduce the rate at which the particles settle. Alternatively, a compound as defined in any one of embodiments 1 to 6 may be dry milled and added to water, containing agents hereinbefore described, to produce the desired end product. Aerosol formulations comprise a compound as defined in any one of embodiments 1 to 6 and a suitable propellant (for example n-butane). A compound as defined in any one of embodiments 1 to 6 may also be dissolved or dispersed in a suitable medium (for example water or a water miscible liquid, such as n-propanol) to provide compositions for use in non-pressurized, hand-actuated spray pumps. A compound as defined in any one of embodiments 1 to 6 may be mixed in the dry state with a pyrotechnic mixture to form a composition suitable for generating, in an enclosed space, a smoke containing the compound. Capsule suspensions (CS) may be prepared in a manner similar to the preparation of EW formulations but with an additional polymerization stage such that an aqueous dispersion of oil droplets is obtained, in which each oil droplet is encapsulated by a polymeric shell and contains a compound as defined in any one of embodiments 1 to 6 and, optionally, a carrier or diluent therefore. The polymeric shell may be produced by either an interfacial polycondensation reaction or by a coacervation procedure. The compositions may provide for controlled release of the compound as defined in any one of embodiments 1 to 6 and they may be used for seed treatment. A compound as defined in any one of embodiments 1 to 6 may also be formulated in a biodegradable polymeric matrix to provide a slow, controlled release of the compound.

A composition may include one or more additives to improve the biological performance of the composition (for example by improving wetting, retention or distribution on surfaces; resistance to rain on treated surfaces; or uptake or mobility of a compound as defined in any one of embodiments 1 to 6). Such additives include surface active agents, spray additives based on oils, for example certain mineral oils or natural plant oils (such as soy bean and rape seed oil), and blends of these with other bio-enhancing adjuvants (ingredients which may aid or modify the action of a compound as defined in any one of embodiments 1 to 6).

A compound as defined in any one of embodiments 1 to 6 may also be formulated for use as a seed treatment, for example as a powder composition, including a powder for dry seed treatment (DS), a water soluble powder (SS) or a water dispersible powder for slurry treatment (WS), or as a liquid composition, including a flowable concentrate (FS), a solution (LS) or a capsule suspension (CS). The preparations of DS, SS, WS, FS and LS compositions are very similar to those of, respectively, DP, SP, WP, SC and DC compositions described above. Compositions for treating seed may include an agent for assisting the adhesion of the composition to the seed (for example a mineral oil or a film-forming barrier). Wetting agents, dispersing agents and emulsifying agents may be surface SFAs of the cationic, anionic, amphoteric or non-ionic type. Suitable SFAs of the cationic type include quaternary ammonium compounds (for example cetyltrimethyl ammonium bromide), imidazolines and amine salts. Suitable anionic SFAs include alkali metals salts of fatty acids, salts of aliphatic monoesters of sulfuric acid (for example sodium lauryl sulfate), salts of sulfonated aromatic compounds (for example sodium dodecylbenzenesulfonate, calcium dodecylbenzenesulfonate, butylnaphthalene sulfonate and mixtures of sodium di-isopropyl- and tri-isopropyl-naphthalene sulfonates), ether sulfates, alcohol ether sulfates (for example sodium laureth-3-sulfate), ether carboxylates (for example sodium laureth-3-carboxylate), phosphate esters (products from the reaction between one or more fatty alcohols and phosphoric acid (predominately mono-esters) or phosphorus pentoxide (predominately di-esters), for example the reaction between lauryl alcohol and tetraphosphoric acid; additionally these products may be ethoxylated), sulfosuccinamates, paraffin or olefine sulfonates, taurates and lignosulfonates.

Suitable SFAs of the amphoteric type include betaines, propionates and glycinates. Suitable SFAs of the non-ionic type include condensation products of alkylene oxides, such as ethylene oxide, propylene oxide, butylene oxide or mixtures thereof, with fatty alcohols (such as oleyl alcohol or cetyl alcohol) or with alkylphenols (such as octylphenol, nonylphenol or octylcresol); partial esters derived from long chain fatty acids or hexitol anhydrides; condensation products of said partial esters with ethylene oxide; block polymers (comprising ethylene oxide and propylene oxide); alkanolamides; simple esters (for example fatty acid polyethylene glycol esters); amine oxides (for example lauryl dimethyl amine oxide); and lecithins. Suitable suspending agents include hydrophilic colloids (such as polysaccharides, polyvinylpyrrolidone or sodium carboxymethylcellulose) and swelling clays (such as bentonite or attapulgite).

A compound as defined in any one of embodiments 1 to 6 may be applied by any of the known means of applying pesticidal compounds. For example, it may be applied, formulated or unformulated, to the pests or to a locus of the pests (such as a habitat of the pests, or a growing plant liable to infestation by the pests) or to any part of the plant, including the foliage, stems, branches or roots, to the seed before it is planted or to other media in which plants are growing or are to be planted (such as soil surrounding the roots, the soil generally, paddy water or hydroponic culture systems), directly or it may be sprayed on, dusted on, applied by dipping, applied as a cream or paste formulation, applied as a vapor or applied through distribution or incorporation of a composition (such as a granular composition or a composition packed in a water-soluble bag) in soil or an aqueous environment.

A compound as defined in any one of embodiments 1 to 6 may also be injected into plants or sprayed onto vegetation using electrodynamic spraying techniques or other low volume methods, or applied by land or aerial irrigation systems.

Compositions for use as aqueous preparations (aqueous solutions or dispersions) are generally supplied in the form of a concentrate containing a high proportion of the active ingredient, the concentrate being added to water before use. These concentrates, which may include DCs, SCs, ECs, EWs, MEs, SGs, SPs, WPs, WGs and CSs, are often required to withstand storage for prolonged periods and, after such storage, to be capable of addition to water to form aqueous preparations which remain homogeneous for a sufficient time to enable them to be applied by conventional spray equipment. Such aqueous preparations may contain varying amounts of a compound as defined in any one of embodiments 1 to 6 (for example 0.0001 to 10%, by weight) depending upon the purpose for which they are to be used.

A compound as defined in any one of embodiments 1 to 6 may be used in mixtures with fertilizers (for example nitrogen-, potassium- or phosphorus-containing fertilizers). Suitable formulation types include granules of fertilizer. The mixtures preferably contain up to 25% by weight of the compound as defined in any one of embodiments 1 to 6.

The invention therefore also provides a fertilizer composition comprising a fertilizer and a compound as defined in any one of embodiments 1 to 6. The compositions of this invention may contain other compounds having biological activity, for example micronutrients or compounds having fungicidal activity or which possess plant growth regulating, herbicidal, insecticidal, nematicidal or acaricidal activity.

The compound as defined in any one of embodiments 1 to 6 may be the sole active ingredient of the composition or it may be admixed with one or more additional active ingredients such as a pesticide, fungicide, synergist, herbicide or plant growth regulator where appropriate. An additional active ingredient may provide a composition having a broader spectrum of activity or increased persistence at a locus; synergize the activity or complement the activity (for example by increasing the speed of effect or overcoming repellency) of the compound as defined in any one of embodiments 1 to 6; or help to overcome or prevent the development of resistance to individual components. The particular additional active ingredient will depend upon the intended utility of the composition. Examples of suitable pesticides include the following:

a) Pyrethroids, such as permethrin, cypermethrin, fenvalerate, esfenvalerate, deltamethrin, cyhalothrin (in particular lambda-cyhalothrin and gamma cyhalothrin), bifenthrin, fenpropathrin, cyfluthrin, tefluthrin, fish safe pyrethroids (for example ethofenprox), natural pyrethrin, tetramethrin, S-bioallethrin, fenfluthrin, prallethrin, acrinathirin, etofenprox or 5-benzyl-3-furylmethyl-(E)-(1R,3S)-2,2-dimethyl-3-(2-oxothiolan-3-ylidenemethyl)cyclopropane carboxylate;

b) Organophosphates, such as profenofos, sulprofos, acephate, methyl parathion, azinphos-methyl, demeton-s-methyl, heptenophos, thiometon, fenamiphos, monocrotophos, profenofos, triazophos, methamidophos, dimethoate, phosphamidon, malathion, chlorpyrifos, phosalone, terbufos, fensulfothion, fonofos, phorate, phoxim, pirimiphos-methyl, pirimiphos-ethyl, fenitrothion, fosthiazate or diazinon;

c) Carbamates (including aryl carbamates), such as pirimicarb, triazamate, cloethocarb, carbofuran, furathiocarb, ethiofencarb, aldicarb, thiofurox, carbosulfan, bendiocarb, fenobucarb, propoxur, methomyl or oxamyl;

d) Benzoyl ureas, such as diflubenzuron, triflumuron, hexaflumuron, flufenoxuron, diafenthiuron, lufeneron, novaluron, noviflumuron or chlorfluazuron;

e) Organic tin compounds, such as cyhexatin, fenbutatin oxide or azocyclotin;

f) Pyrazoles, such as tebufenpyrad, tolfenpyrad, ethiprole, pyriprole, fipronil, and fenpyroximate;

g) Macrolides, such as avermectins or milbemycins, for example abamectin, emamectin benzoate, ivermectin, milbemycin, spinosad, azadirachtin, milbemectin, lepimectin or spinetoram;

h) Hormones or pheromones;

i) Organochlorine compounds, such as endosulfan (in particular alpha-endosulfan), benzene hexachloride, DDT, chlordane or dieldrin;

j) Amidines, such as chlordimeform or amitraz;

k) Fumigant agents, such as chloropicrin, dichloropropane, methyl bromide or metam;

l) Neonicotinoid compounds, such as imidacloprid, thiacloprid, acetamiprid, nitenpyram, dinotefuran, thiamethoxam, clothianidin, or nithiazine;

m) Diacylhydrazines, such as tebufenozide, chromafenozide or methoxyfenozide;

n) Diphenyl ethers, such as diofenolan or pyriproxifen;

o) Ureas such as lndoxacarb or metaflumizone;

p) Ketoenols, such as Spirotetramat, spirodiclofen or spiromesifen;

q) Diamides, such as flubendiamide, chlorantraniliprole (Rynaxypyr®) or cyantraniliprole;

r) Essential oils such as Bugoil®—(PlantImpact); or

s) a comopund selected from buprofezine, flonicamid, acequinocyl, bifenazate, cyenopyrafen, cyflumetofen, etoxazole, flometoquin, fluacrypyrim, fluensulfone, flufenerim, flupyradifuone, harpin, iodomethane, dodecadienol, pyridaben, pyridalyl, pyrimidifen, flupyradifurone, 4-[(6-Chloro-pyridin-3-ylmethyl)-(2,2-difluoro-ethyl)-amino]-5H-furan-2-one (DE 102006015467), CAS: 915972-17-7 (WO 2006129714; WO 2011/147953; WO 2011/147952), CAS: 26914-55-8 (WO 2007/020986), chlorfenapyr, pymetrozine, sulfoxaflor and pyrifluqinazon.

In addition to the major chemical classes of pesticide listed above, other pesticides having particular targets may be employed in the composition, if appropriate for the intended utility of the composition. For instance, selective insecticides for particular crops, for example stemborer specific insecticides (such as cartap) or hopper specific insecticides (such as buprofezin) for use in rice may be employed. Alternatively insecticides or acaricides specific for particular insect species/stages may also be included in the compositions (for example acaricidal ovo-larvicides, such as clofentezine, flubenzimine, hexythiazox or tetradifon; acaricidal motilicides, such as dicofol or propargite; acaricides, such as bromopropylate or chlorobenzilate; or growth regulators, such as hydramethylnon, cyromazine, methoprene, chlorfluazuron or diflubenzuron).

Examples of fungicidal compounds which may be included in the composition of the invention are (E)-N-methyl-2-[2-(2,5-dimethylphenoxymethyl)phenyl]-2-methoxy-iminoacetamide (SSF-129), 4-bromo-2-cyano-N,N-dimethyl-6-trifluoromethylbenzimidazole-1-sulfonamide, α-[N-(3-chloro-2,6-xylyl)-2-methoxyacetamido]-γ-butyrolactone, 4-chloro-2-cyano-N,N-dimethyl-5-p-tolylimidazole-1-sulfonamide (IKF-916, cyamidazosulfamid), 3-5-dichloro-N-(3-chloro-1-ethyl-1-methyl-2-oxopropyl)-4-methylbenzamide (RH-7281, zoxamide), N-allyl-4,5,-dimethyl-2-trimethylsilylthiophene-3-carboxamide (MON65500), N-(1-cyano-1,2-dimethylpropyl)-2-(2,4-dichlorophenoxy)propionamide (AC382042), N-(2-methoxy-5-pyridyl)-cyclopropane carboxamide, acibenzolar (CGA245704), alanycarb, aldimorph, anilazine, azaconazole, azoxystrobin, benalaxyl, benomyl, biloxazol, bitertanol, blasticidin S, bromuconazole, bupirimate, captafol, captan, carbendazim, carbendazim chlorhydrate, carboxin, carpropamid, carvone, CGA41396, CGA41397, chinomethionate, chlorothalonil, chlorozolinate, clozylacon, copper containing compounds such as copper oxychloride, copper oxyquinolate, copper sulfate, copper tallate and Bordeaux mixture, cymoxanil, cyproconazole, cyprodinil, debacarb, di-2-pyridyl disulfide 1,1′-dioxide, dichlofluanid, diclomezine, dicloran, diethofencarb, difenoconazole, difenzoquat, diflumetorim, O,O-di-iso-propyl-S-benzyl thiophosphate, dimefluazole, dimetconazole, dimethomorph, dimethirimol, diniconazole, dinocap, dithianon, dodecyl dimethyl ammonium chloride, dodemorph, dodine, doguadine, edifenphos, epoxiconazole, ethirimol, ethyl-(Z)-N-benzyl-N-([methyl(methyl-thioethylideneaminooxycarbonyl)amino]thio)-β-alaninate, etridiazole, famoxadone, fenamidone (RPA407213), fenarimol, fenbuconazole, fenfuram, fenhexamid (KBR2738), fenpiclonil, fenpropidin, fenpropimorph, fentin acetate, fentin hydroxide, ferbam, ferimzone, fluazinam, fludioxonil, flumetover, fluoroimide, fluquinconazole, flusilazole, flutolanil, flutriafol, folpet, fuberidazole, furalaxyl, furametpyr, guazatine, hexaconazole, hydroxyisoxazole, hymexazole, imazalil, imibenconazole, iminoctadine, iminoctadine triacetate, ipconazole, iprobenfos, iprodione, iprovalicarb (SZX0722), isopropanyl butyl carbamate, isoprothiolane, kasugamycin, kresoxim-methyl, LY186054, LY211795, LY248908, mancozeb, maneb, mefenoxam, mepanipyrim, mepronil, metalaxyl, metconazole, metiram, metiram-zinc, metominostrobin, myclobutanil, neoasozin, nickel dimethyldithiocarbamate, nitrothal-isopropyl, nuarimol, ofurace, organomercury compounds, oxadixyl, oxasulfuron, oxolinic acid, oxpoconazole, oxycarboxin, pefurazoate, penconazole, pencycuron, phenazin oxide, phosetyl-Al, phosphorus acids, phthalide, picoxystrobin (ZA1963), polyoxin D, polyram, probenazole, prochloraz, procymidone, propamocarb, propiconazole, propineb, propionic acid, pyrazophos, pyrifenox, pyrimethanil, pyroquilon, pyroxyfur, pyrrolnitrin, quaternary ammonium compounds, quinomethionate, quinoxyfen, quintozene, sipconazole (F-155), sodium pentachlorophenate, spiroxamine, streptomycin, sulfur, tebuconazole, tecloftalam, tecnazene, tetraconazole, thiabendazole, thifluzamid, 2-(thiocyanomethylthio)benzothiazole, thiophanate-methyl, thiram, timibenconazole, tolclofos-methyl, tolylfluanid, triadimefon, triadimenol, triazbutil, triazoxide, tricyclazole, tridemorph, trifloxystrobin (CGA279202), triforine, triflumizole, triticonazole, validamycin A, vapam, vinclozolin, zineb, ziram; N-[9-(dichloromethylene)-1,2,3,4-tetrahydro-1,4-methanonaphthalen-5-yl]-3-(difluoromethyl)-1-methyl-1H-pyrazole-4-carboxamide [1072957-71-1], 1-methyl-3-difluoromethyl-1H-pyrazole-4-carboxylic acid (2-dichloromethylene-3-ethyl-1-methyl-indan-4-yl)-amide, and 1-methyl-3-difluoromethyl-4H-pyrazole-4-carboxylic acid [2-(2,4-dichloro-phenyl)-2-methoxy-1-methyl-ethyl]-amide.

Preferred additional pesticidally active ingredients are those selected from neonicotinoids, pyrethroids, strobilurins, triazoles and carboxamides (SDHI inhibitors). Pyrethroids are of interest of which lambda-cyhalothrin is of particular interest. Combinations of compounds of the invention and pyrethroids, in particular lambda-cyhalothrin, exhibit synergistic control of stinkbugs (according to the Colby formula), in particular Euschistus, e.g. Euschistus heros.

In a further aspect of the invention there is provided a method comprising applying to a crop of plants, the locus thereof, or propagation material thereof, a compound as defined in any one of embodiments 1 to 6 and a further pesticide, particularly in a synergistically effective amount, wherein the method is for control and/or prevention of stinkbugs, preferably Euschistus, e.g. Euschistus heros.

The compounds of the invention may be mixed with soil, peat or other rooting media for the protection of plants against seed-borne, soil-borne or foliar fungal diseases. Examples of suitable synergists for use in the compositions include piperonyl butoxide, sesamex, safroxan and dodecyl imidazole.

Suitable herbicides and plant-growth regulators for inclusion in the compositions will depend upon the intended target and the effect required. An example of a rice selective herbicide which may be included is propanil. An example of a plant growth regulator for use in cotton is PIX™.

Some mixtures may comprise active ingredients which have significantly different physical, chemical or biological properties such that they do not easily lend themselves to the same conventional formulation type. In these circumstances other formulation types may be prepared. For example, where one active ingredient is a water insoluble solid and the other a water insoluble liquid, it may nevertheless be possible to disperse each active ingredient in the same continuous aqueous phase by dispersing the solid active ingredient as a suspension (using a preparation analogous to that of an SC) but dispersing the liquid active ingredient as an emulsion (using a preparation analogous to that of an EW). The resultant composition is a suspoemulsion (SE) formulation.

Unless otherwise stated the weight ratio of the compound as defined in any one of embodiments 1 to 6 (A) with an additional active ingredient (B) may generally be between 1000:1 and 1:1000. In other embodiments that weight ratio of A to B may be between 500:1 to 1:500, for example between 100:1 to 1:100, for example between 1:50 to 50:1, for example 1:20 to 20:1, for example 1:10 to 10:1, for example 1:5 to 5:1, for example 1:1.

Compositions may also be prepared by premixing prior to application, e.g. as a readymix or tankmix, or by simultaneous application or sequential application to the plant.

The invention will now be illustrated by the following non-limiting Examples. All citations are incorporated by reference.

Experimental

Biological Testing

Insecticidal activity against Euschistus heros (neotropical brown stink bug): contact/feeding activity of compounds 1 and 3 according to the invention and 2 and 4 as comparison:

Two week old soybean plants were sprayed in a turn table spray chamber with the diluted spray solutions. After drying, two soybean seeds were added and plants were infested with ten N-2 nymphs of the neotropical brown stink bug Euschistus heros in plastic test boxes. Boxes were incubated in a climate chamber at 25° C. and 60% relative humidity. Evaluation is done 5 days after infestation on mortality and growth effect.

Compounds 1 and 3 are disclosed in WO 2014/122083 as examples Ic-1 (p. 76) and Ic-2 (p. 82). Compounds 2 and 4 are disclosed in WO 2012/107434 as compound A1 and A103 in Table A of WO2012/107434.

| | | Concentration | |
|---|---|---|---|
| No. | Compound structure | (ppm) | Mortality (%) |
| 1 | 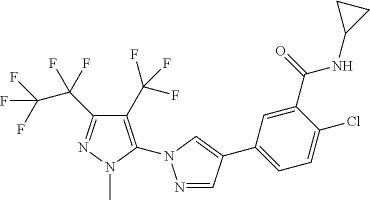 [SMILES: Cn1nc(C(F)(F)C(F)(F)F)c(C(F)(F)F)c1-n1cc(-c2ccc(Cl)c(C(=O)NC3CC3)c2)cn1] | 3 0.8 0.2 0.05 0.0125 | 100 100 95 50 35 |
| 2 | 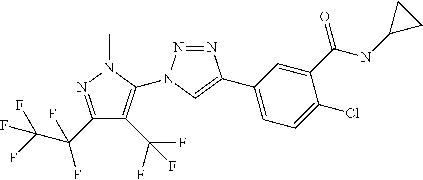 [SMILES: Cn1nc(C(F)(F)C(F)(F)F)c(C(F)(F)F)c1-n1cc(-c2ccc(Cl)c(C(=O)NC3CC3)c2)nn1] | 3 0.8 0.2 0.05 0.0125 | 100 35 20 10 0 |
| 3 | 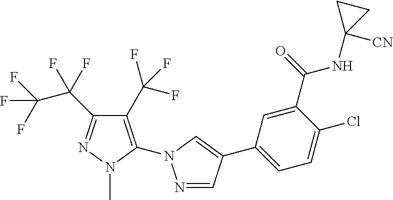 [SMILES: Cn1nc(C(F)(F)C(F)(F)F)c(C(F)(F)F)c1-n1cc(-c2ccc(Cl)c(C(=O)NC3(C#N)CC3)c2)cn1] | 3 0.8 0.2 0.05 0.0125 | 100 95 95 35 15 |
| 4 | 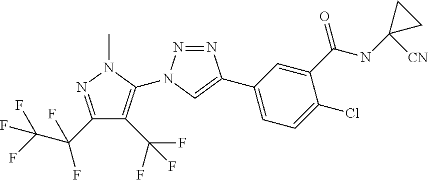 [SMILES: Cn1nc(C(F)(F)C(F)(F)F)c(C(F)(F)F)c1-n1cc(-c2ccc(Cl)c(C(=O)NC3(C#N)CC3)c2)nn1] | 3 0.8 0.2 0.05 0.0125 | 95 20 0 — — |

1. A method of controlling and/or preventing infestation of stinkbugs comprising applying to a crop of plants, the locus thereof, or propagation material thereof, a compound of formula (I) 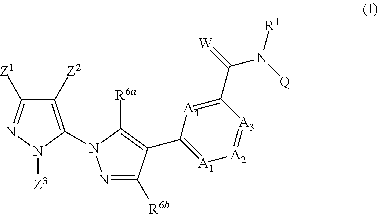
wherein
R¹ is selected from H, C₁₋C₆-alkyl, C₃₋C₆ alkenyl, C₃₋C₆ alkinyl, C₃₋C₇ cycloalkyl, C₃₋C₇ cycloalkyl-C₁₋C₃-alkyl, C₁₋C₆-alkylcarbonyl, C₁₋C₆-alkoxycarbonyl, aryl(C₁₋C₃)-alkyl and heteroaryl(C₁₋C₃)-alkyl, wherein each of C₁₋C₆-alkyl, C₃₋C₆ alkenyl, C₃₋C₆ alkinyl, C₃₋C₇ cycloalkyl, C₃₋C₇ cycloalkyl-C₁₋C₃-alkyl, C₁₋C₆-alkylcarbonyl, C₁₋C₆-alkoxycarbonyl, aryl(C₁₋C₃)-alkyl and heteroaryl(C₁₋C₃)-alkyl is unsubstituted or substituted with 1 to 5 substituents independently selected from halogen, cyano, C₁₋C₆-alkoxy and C₁₋C₆-alkoxycarbonyl;
Q is selected from H, hydroxy, HC(═O)—, C₁₋C₆-alkyl, C₁₋C₆-alkoxy, C₃₋C₆ alkenyl, C₃₋C₆ alkinyl, C₃₋C₇ cycloalkyl, C₃₋C₇ heterocycloalkyl, C₃-C₇ cycloalkyl-C₁₋C₃-alkyl, C₁₋C₃-alkyl-C₃₋C₇ cycloalkyl, aryl(C₁₋C₃)-alkyl, heteroaryl(C₁₋C₃)-alkyl, N—C₁₋C₆-alkylamino, N—C₁₋C₆-alkylcarbonylamino and N,N-di (C₁₋C₆-alkyl)amino, wherein each of C₁₋C₆-alkyl, C₁₋C₆-alkoxy, C₃₋C₆ alkenyl, C₃₋C₆ alkinyl, C₃₋C₇ cycloalkyl, C₃₋C₇ heterocycloalkyl, C₃₋C₇ cycloalkyl-C₁₋C₃-alkyl, C₁₋C₃-alkyl-C₃₋C₇ cycloalkyl, aryl(C₁₋C₃)-alkyl, heteroaryl(C₁₋C₃)-alkyl, N—C₁₋C₆-alkylamino, N—C₁₋C₆-alkylcarbonylamino and N,N-di (C₁₋C₆-alkyl)amino is unsubstituted or substituted with 1 to 5 substituents independently selected from halogen, hydroxyl, nitro, amino, cyano, C₁₋C₆-alkoxy, C₁₋C₆-alkoxycarbonyl, hydroxycarbonyl, C₁₋C₆-alkylcarbamoyl, C₃₋C₆-cycloalkylcarbamoyl and phenyl; A₁ is CR² or N;
A₂ is CR³ or N;
A₃ is CR⁴ or N;
A₄ is CR⁵ or N;
with the proviso that no more than 3 of A₁, A₂, A₃ and A₄ are N;
R², R³, R⁴ and R⁵ are independently selected from H, halogen, cyano, nitro, C₁₋C₆-alkyl, C₁₋C₆-alkoxy, N—C₁₋C₆-alkoxy-imino-C₁₋C₃-alkyl, C₁₋C₆-alkylsulfanyl, C₁₋C₆-alkylsulfinyl, C₁₋C₆-alkylsulfonyl, N—C₁₋C₆-alkylamino and N,N-di-C₁₋C₆-alkylamino, wherein each of C₁₋C₆-alkyl, C₁₋C₆-alkoxy, N—C₁₋C₆-alkoxy-imino-C₁₋C₃-alkyl, C₁₋C₆-alkylsulfanyl, C₁₋C₆-alkylsulfinyl, C₁₋C₆-alkylsulfonyl, N—C₁₋C₆-alkylamino and N,N-di-C₁₋C₆-alkylamino is unsubstituted or substituted with 1 to 5 substituents independently selected from halogen, hydroxy, nitro, amino, cyano, C₁₋C₆-alkoxy, C₁₋C₆-alkoxycarbonyl, hydroxycarbonyl, C₁₋C₆-alkylcarbamoyl, C₃₋C₆-cycloalkylcarbamoyl and phenyl;
W is O or S;
R^{6a} and R^{6b} are independently selected from H, halogen, cyano, nitro, amino, C₁₋C₆-alkyl, C₁₋C₆-alkoxy, C₁₋C₆-alkylcarbonyl, C₁₋C₆-alkylsulfanyl, C₁₋C₆-alkylsulfinyl, C₁₋C₆-alkylsulfonyl, wherein each of C₁₋C₆-alkyl, C₁₋C₆-alkoxy, C₁₋C₆-alkylcarbonyl, C₁₋C₆-alkylsulfanyl, C₁₋C₆-alkylsulfinyl, C₁₋C₆-alkylsulfonyl is unsubstituted or substituted with 1 to 5 halogen;
Z¹ is selected from C₁₋C₆-halogenalkyl, C₃₋C₆-cycloalkyl and C₃₋C₆-halogencycloalkyl, wherein each of C₁₋C₆-halogenalkyl, C₃₋C₆-cycloalkyl and C₃₋C₆-halogencycloalkyl is unsubstituted or substituted with 1 to 5 substituents independently selected from halogen, hydroxy, nitro, amino, cyano, C₁₋C₆-alkoxy, C₁₋C₆-alkoxycarbonyl, hydroxycarbonyl, C₁₋C₆-alkylcarbamoyl, C₃₋C₆-cycloalkylcarbamoyl and phenyl;
Z² is selected from H, halogen, cyano, nitro, amino, C₁₋C₆-alkyl, C₁₋C₆-alkylcarbonyl, C₁₋C₆-alkylsulfanyl, C₁₋C₆-alkylsulfinyl and C₁₋C₆-alkylsulfonyl, wherein each of C₁₋C₆-alkyl, C₁₋C₆-alkylcarbonyl, C₁₋C₆-alkylsulfanyl, C₁₋C₆-alkylsulfinyl and C₁₋C₆-alkylsulfonyl is unsubstituted or substituted with 1 to 5 substituents independently selected from halogen, hydroxy, nitro, amino, cyano, C₁₋C₆-alkoxy, C₁₋C₆-alkoxycarbonyl, hydroxycarbonyl, C₁₋C₆-alkylcarbamoyl, C₃₋C₆-cycloalkylcarbamoyl and phenyl;
Z³ is selected from C₁₋C₆-alkyl, C₁₋C₆-cycloalkyl, C₁₋C₆-alkenyl, C₁₋C₆-alkinyl, aryl and heteroaryl, wherein each of C₁₋C₆-alkyl, C₁₋C₆-cycloalkyl, C₁₋C₆-alkenyl, C₁₋C₆-alkinyl, aryl and heteroaryl is unsubstituted or substituted with 1 to 5 substituents independently selected from halogen, hydroxy, nitro, amino, cyano, C₁₋C₆-alkoxy, C₁₋C₆-alkoxycarbonyl, hydroxycarbonyl, C₁₋C₆-alkylcarbamoyl, C₃₋C₆-cycloalkylcarbamoyl and phenyl;
or an agrochemically acceptable salt or N-oxide thereof.

2. The method according to claim 1, wherein
R¹ is selected from H, methyl, ethyl, n-propyl, isopropyl, n-butyl, isobutyl, s-butyl, t-butyl, methoxymethyl, ethoxymethyl, propoxymethyl, methylcarbonyl, ethylcarbonyl, n-propylcarbonyl, isopropylcarbonyl, s-butylcarbonyl, t-butylcarbonyl, methoxycarbonyl, ethoxycarbonyl, n-propoxycarbonyl, isopropoxycarbonyl, s-butoxycarbonyl, t-butoxycarbonyl, cyanomethyl, 2-cyanoethyl, benzyl, 4-methoxybenzyl, pyrid-2-yl-methyl, pyrid-3-yl-methyl, pyrid-4-yl-methyl and 4-chlor-pyrid-3-yl-methyl;
Q is selected from H, methyl, ethyl, n-propyl, 1-methylethyl, 1,1-dimethylethyl, 1-methylpropyl, n-butyl, 2-methylpropyl, 2-methylbutyl, hydroxyethyl, 2-hydroxypropyl, cyanomethyl, 2-cyanoethyl, 2-fluorethyl, 2,2-difluorethyl, 2,2,2-trifluorethyl, 1-trifluormethylethyl, 2,2-difluorpropyl, 3,3,3-trifluorpropyl, 2,2-dimethyl-3-fluorpropyl, cyclopropyl, 1-cyano-cyclopropyl, 1-methoxycarbonyl-cyclopropyl, 1-(N-methylcarbamoyl)cyclopropyl, 1-carbamoyl-cyclopropyl, 1-carbamothioyl-cyclopropyl, 1-(N-cyclopropylcarbamoyl)cyclopropyl, cyclopropyl-methyl, cyclobutyl, cyclopentyl, cyclohexyl, 1-cyclopropylethyl, bis(cyclopropyl)methyl, 2,2-dimethylcyclopropyl-methyl, 2-phenylcyclopropyl, 2,2-dichlorcyclopropyl, trans-2-chlorcyclopropyl, cis-2-chlorcyclopropyl, 2,2-difluorcyclopropyl, trans-2-fluorcyclopropyl, cis-2-fluorcyclopropyl, trans-4-hydroxycyclohexyl, 4-trifluormethylcyclohexyl, prop-2-enyl, 2-methylprop-2-enyl, prop-2-inyl, 1,1-dimethylbut-2-inyl, 3-chlor-prop-2-enyl, 3-fluor-prop-2-enyl, 3,3-dichlor-prop-2-enyl, 3,3-dichlor-1,1-dimethylprop-2-enyl, oxetan-3-yl, thietan-3-yl, l-oxido-thietan-3-yl, l,l-dioxido-thietan-3-yl, isoxazol-3-ylmethyl, l,2,4-triazol-3-ylmethyl, 3-methyloxetan-3-ylmethyl, benzyl, 2,6-difluorphenylmethyl, 3-fluorphenylmethyl, 2-fluorphenylmethyl, 2,5-difluorphenylmethyl, 1-phenylethyl, 4-chlorphenylethyl, 2-trifluormethylphenylethyl, 1-pyridin-2-ylethyl, pyridin-2-ylmethyl, 5-fluorpyridin-2-ylmethyl, (6-chlor-pyridin-3-yl)methyl, pyrimidin-2-ylmethyl, methoxy, 2-ethoxyethyl, 2-methoxyethyl, 2-(methylsulfanyl)ethyl, l-methyl-2-(ethylsulfanyl)ethyl, 2-methyl-1-(methylsulfanyl)propan-2-yl, methoxycarbonyl, methoxycarbonylmethyl, NH₂, N-ethylamino, N-allylamino, N,N-dimethylamino and N,N-diethylamino; or
Q is selected from phenyl, naphthyl, pyridazin, pyrazin, pyrimidin, triazin, pyridin, pyrazol, thiazol, isothiazol, oxazol, isoxazol, triazol, imidazol, furan, thiophen, pyrrol, oxadiazol, and thiadiazol, each of which is unsubstituted or substituted with 1 to 4 substituents independently selected from V;
V is selected from fluoro, chloro, bromo, iodo, Cyano, nitro, methyl, ethyl, difluormethyl, trichloromethyl, chlordifluoromethyl, dichlorofluoromethyl, trifluoromethyl, 1-fluoroethyl, 2-fluoroethyl, 2,2-difluoroethyl, 2,2,2-trifluoroethyl, 1,2,2,2-tetrafluoroethyl, 1-chloro-1,2,2,2-tetrafluoroethyl, 2,2,2-trichloroethyl, 2-chloro-2,2-difluoroethyl, 1,1-dilfluoroethyl, pentafluoroethyl heptafluoro-n-propyl, heptafluoro-isopropyl, nonafluoro-n-butyl, cyclopropyl, cyclobutyl, methoxy, ethoxy, n-propoxy, 1-methylethoxy, fluormethoxy, difluormethoxy, chloro-difluormethoxy, dichloro-fluoromethoxy, trifluoromethoxy, 2,2,2-trifluoroethoxy, 2-chloro-2,2-difluorethoxy, pentafluorethoxy, N-methoxyiminomethyl, l-(N-methoxyimino)-ethyl, methylsulfanyl, methylsulfonyl, methylsulfinyl, trifluormethylsulfonyl, trifluormethylsulfinyl, trifluormethylsulfanyl and N,N-dimethylamino;
W is O or S;
A₁ is CR² or N;
A₂ is CR³ or N;
A₃ is CR⁴ or N;
A₄ is CR⁵ or N;
with the proviso that no more than 3 of A₁, A₂, A₃ and A₄ are N;
R² and R⁵ are independently selected from H, methyl, fluoro and chloro;
R³ and R⁴ are independently selected from H, fluoro, chloro, bromo, iodo, cyano, nitro, methyl, ethyl, fluoromethyl, difluoromethyl, chlordifluormethyl, trifluormethyl, 2,2,2-trilfluoroethyl, methoxy, ethoxy, n-propoxy, 1-methylethoxy, fluoromethoxy, difluoromethoxy, chloro-difluoromethoxy, dichloro-fluoromethoxy, trifluoromethoxy, 2,2,2-trifluoroethoxy, 2-chloro-2,2-difluorethoxy, pentafluoroethoxy, N-methoxyiminomethyl, l-(N-methoxyimino)-ethyl, methylsulfanyl, trifluoromethylsulfanyl, methylsulfonyl, methylsulfinyl, trifluormethylsulfonyl and trifluormethylsulfinyl;
R^{6a} and R^{6b} are independently selected from halogen, cyano, nitro, amino, methyl, ethyl, propyl, 1-methylethyl, tert-butyl, trifluoromethyl, difluoromethyl, methoxy, ethoxy, trifluoromethoxy, 2,2-difluoroethoxy, 2,2,2-trifluoroethoxy, methylcarbonyl, ethylcarbonyl, trifluoromethylcarbonyl, methylsulfanyl, methylsulfinyl, methylsulfonyl, trifluoromethylsulfonyl, trifluoromethylsulfanyl and trilfluoromethylsulfinyl;
Z¹ is selected from methyl, ethyl, 1,1-dimethylethyl, difluoromethyl, trichloromethyl, chlorodifluoromethyl, dichlorofluoromethyl, trifluoromethyl, bromodichloromethyl, 1-fluoroethyl, 1-fluoro-1-methylethyl, 2-fluoroethyl, 2,2-difluorethyl, 2,2,2-trifluoroethyl, 1,2,2,2-tetrafluoroethyl, 1-chloro-1,2,2,2-tetrafluoroethyl, 2,2,2-trichloroethyl, 2-chloro-2,2-difluoroethyl, 1,1-difluoroethyl, pentafluoroethyl heptafluor-n-propyl, heptafluor-isopropyl, nonafluoro-n-butyl, cyclopropyl, 1-chlorocyclopropyl, 1-fluorocyclopropyl, 1-bromocyclopropyl, 1-cyano-cyclopropyl, 1-trifluoromehtyl-cyclopropyl, cyclobutyl and 2,2-Difluor-l-methyl-cyclopropyl;
Z² is selected from H, halogen, cyano, nitro, amino, methyl, ethyl, 1,1-dimethylethyl, difluoromethyl, trichloromethyl, chlorodifluoromethyl, dichlorofluoromethyl, trifluoromethyl, bromodichloromethyl, 1-fluoroethyl, 1-fluoro-1 methylethyl, 2-fluoroethyl, 2,2-difluoroethyl, 2,2,2-trifluoroethyl, 1,2,2,2-tetrafluoroethyl, 1-chlor-1,2,2,2-tetrafluoroethyl, 2,2,2-trichloroethyl, 2-chloro-2,2-difluoroethyl, 1,1-difluoroethyl, pentafluoroethyl heptafluoro-n-propyl, heptafluoro-isopropyl, nonafluoro-n-butyl, methylsulfanyl, methylsulfinyl, methylsulfonyl, ethylthio, ethylsulfinyl, ethylsulfonyl, trifluoromethylsulfanyl, trifluoromethylsulfinyl, trifluoromethylsulfonyl, chloro-difluoromethylsulfanyl, chloro-difluoromethylsulfinyl, chloro-difluoromethylsulfonyl, dichloro-fluoromethylsulfanyl, dichloro-fluoromethylsulfinyl, dichloro-fluoromethylsulfonyl; and
Z³ is selected from H, methyl, ethyl, n-propyl, isopropyl, n-butyl, isobutyl, s-butyl, t-butyl, ethenyl, 1-propenyl, 1-propinyl, 1-butinyl, difluoromethyl, trichloromethyl, chlorodifluoromethyl, dichlorofluoromethyl, trifluoromethyl, 1-fluoroethyl, 1 fluoro-1-methylethyl, 2-fluoroethyl, 2,2-difluoroethyl, 2,2,2-trifluoroethyl, phenyl, 2-chlorophenyl, 3-chlorophenyl, 4-chlorophenyl, 2,5-dichlorophenyl, 3,4-dichlorophenyl, 2,6-dichlorophenyl 2,6-dichloro-4-trifluoromethylphenyl and 3-chlor-5-trifluormethylpyridin-2-yl.

3. The method according to claim 1, wherein R¹ is H, methyl, ethyl, n-propyl, n-propylcarbonyl and propenyl;
Q is selected from 1-cyano-cyclopropyl, benzyl, cyclopropyl, 2-thienylmethyl, carbamothioylcyclopropyl, pyrid-4-yl, 2,2,2-trifluorethyl, methylsulfonyl, thietan-3-yl and 1-carbamoylcyclopropyl;
W is O;
A¹ and A4 are CH;
A² is CH or CF;
A³ is CH or CCl;
R^{6a} is H or methyl;
R^{6b} is H, methyl or CF₃;
Z¹ is CF₂CF₃;
Z² is CF₃;
Z³ is selected from methyl, ethyl, phenyl, 4-NO₂-phenyl and 3-chlorpyridin-2-yl.

4. The method according to claim 1, wherein
R¹ is H or methyl;
Q is selected from 1-cyano-cyclopropyl, benzyl, cyclopropyl, 2-thienylmethyl, carbamothioylcyclopropyl, pyrid-4-yl, 2,2,2-trifluorethyl, methylsulfonyl, thietan-3-yl and 1-carbamoylcyclopropyl;
W is O;
A¹ and A⁴ are CH;
A² is N;
A³ is CH or CCl;
R^{6a} is H or methyl;
R^{6b} is H, methyl or CF₃;
Z¹ is CF₂CF₃;
Z² is CF₃;
Z³ is methyl, ethyl, phenyl, 4-NO₂-phenyl, 3-chloropyridin-2-yl.

5. The method according to claim 1, wherein the compound is selected from a compound of formula (I) 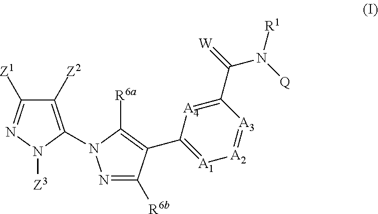
wherein Z¹, Z², Z³, R^{6a}, R^{6b}, A₁, A₂, A₃, A₄, W, Q and R¹ are as defined in the table below

| Ex no | Z¹ | Z² | Z³ | R¹ | R^{6a} | R^{6b} | A₄ | A₃ | A₂ | A₁ | W | Q |
|---|---|---|---|---|---|---|---|---|---|---|---|---|
| Ic-2 | CF2CF3 | CF3 | CH3 | H | H | H | C—H | C—Cl | C—H | C—H | O | 1-Cyano-cyclopropyl |
| Ic-3 | CF2CF3 | CF3 | CH3 | H | H | H | C—H | C—Cl | C—H | C—H | O | Benzyl |
| Ic-4 | CF2CF3 | CF3 | CH3 | H | H | CF3 | C—H | C—Cl | C—H | C—H | O | Cyclopropyl |
| Ic-5 | CF2CF3 | CF3 | CH3 | H | CH3 | CF3 | C—H | C—Cl | C—H | C—H | O | Cyclopropyl |
| Ic-6 | CF2CF3 | CF3 | Phenyl | H | H | H | C—H | C—Cl | C—H | C—H | O | Cyclopropyl |
| Ic-7 | CF2CF3 | CF3 | Phenyl | H | H | H | C—H | C—Cl | C—H | C—H | O | 1-Cyano-cyclopropyl |
| Ic-8 | CF2CF3 | CF3 | 4-N02- | H | H | H | C—H | C—Cl | C—H | C—H | O | Cyclopropyl |
| | | | Phenyl | | | | | | | | | |
| Ic-9 | CF2CF3 | CF3 | CH3 | H | CH3 | CH3 | C—H | C—Cl | C—H | C—H | O | Cyclopropyl |
| Ic-10 | CF2CF3 | CF3 | CH3 | H | H | H | C—H | C—Cl | C—H | C—H | O | 2-Thienylmethyl |
| Ic-11 | CF2CF3 | CF3 | CH3 | H | H | H | C—H | C—Cl | C—H | C—H | O | 1- |
| | | | | | | | | | | | | Carbamothioylcyclopropyl |
| Ic-12 | CF2CF3 | CF3 | CH3 | H | H | CH3 | C—H | C—Cl | C—H | C—H | O | Cyclopropyl |
| Ic-13 | CF2CF3 | CF3 | CH3 | H | CH3 | H | C—H | C—Cl | C—H | C—H | O | Cyclopropyl |
| Ic-14 | CF2CF3 | CF3 | 3-Chlorpyridin-2-yl | H | H | H | C—H | C—Cl | C—H | C—H | O | Cyclopropyl |
| Ic-15 | CF2CF3 | CF3 | 3- | H | H | H | C—H | C—Cl | C—H | C—H | O | 1-Cyano-cyclopropyl |
| | | | Chlorpyridin-2-yl | | | | | | | | | |
| Ic-16 | CF2CF3 | CF3 | CH2CH3 | H | H | H | C—H | C—Cl | C—H | C—H | O | Cyclopropyl |
| Ic-17 | CF2CF3 | CF3 | CH3 | H | H | H | C—H | C—H | C—H | C—H | O | Benzyl |
| Ic-18 | CF2CF3 | CF3 | CH3 | H | H | H | C—H | C—H | C—H | C—H | O | Cyclopropyl |
| Ic-19 | CF2CF3 | CF3 | CH3 | H | H | H | C—H | C—H | C—H | C—H | O | 1-Cyano-cyclopropyl |
| Ic-20 | CF2CF3 | CF3 | CH3 | H | H | H | C—H | C—H | C—H | C—H | O | 2-Thienylmethyl |
| Ic-21 | CF2CF3 | CF3 | CH2CH3 | H | H | H | C—H | C—Cl | C—H | C—H | O | 1-Cyano-cyclopropyl |
| Ic-22 | CF2CF3 | CF3 | CH3 | H | H | H | C—H | C—Cl | C—H | C—H | O | Pyrid-4-yl |
| Ic-23 | CF2CF3 | CF3 | CH3 | H | H | H | C—H | C—Cl | C—H | C—H | O | 2,2,2-Trifluorethyl |
| Ic-24 | CF2CF3 | CF3 | CH3 | H | H | H | C—H | C—Cl | C—F | C—H | O | Cyclopropyl |
| Ic-25 | CF2CF3 | CF3 | CH3 | H | H | H | C—H | C—Cl | C—H | C—H | O | 4-Chlorphenyl |
| Ic-26 | CF2CF3 | CF3 | CH3 | H | H | H | C—H | C—Cl | C—H | C—H | O | Methylsulfonyl |
| Ic-27 | CF2CF3 | CF3 | CH3 | H | H | H | C—H | C—Cl | C—F | C—H | O | 1-Cyano-cyclopropyl |
| Ic-28 | CF2CF3 | CF3 | CH3 | H | H | H | C—H | C—Cl | C—H | C—H | O | Thietan-3-yl |
| Ic-29 | CF2CF3 | CF3 | CH3 | H | H | H | C—H | C—Cl | C—H | C—H | O | 1-Carbamoylcyclopropyl |
| Ic-30 | CF3 | CN | Me | H | H | H | C—H | C—Cl | C—H | C—H | O | cyclopropyl |
| Ic-31 | CF2CF3 | CF3 | Me | H | H | H | C—H | C—Cl | C—H | C—H | O | 2-oxo-2-[(2,2,2- |
| | | | | | | | | | | | | trifluoroethyl)amino]ethyl |
| Ic-32 | CF2CF3 | CF3 | Me | H | H | H | C—H | C—Cl | C—H | C—H | O | 1-(CF3)cyclopropyl |
| Ic-33 | CF2CF3 | CF3 | Me | H | H | H | C—F | C—H | C—H | C—H | O | cyclopropyl |
| Ic-34 | CF2CF3 | CF3 | Me | H | H | H | C—H | C—Br | C—H | C—H | O | 1-cyanocyclopropyl |
| Ic-35 | CF2CF3 | CF3 | Me | H | H | H | C—H | C—H | C—H | C—H | O | H |
| Ic-36 | CF2CF3 | CF3 | Me | H | H | H | C—H | C—F | C—H | C—H | O | 1-cyanocyclopropyl |
| Ic-37 | CF2CF3 | CF3 | Me | H | H | H | C—H | C—F | C—H | C—H | O | cyclopropyl |
| Ic-38 | CF2CF3 | CF3 | Me | H | H | H | C—H | C—H | C—F | C—H | O | 1-cyanocyclopropyl |
| Ic-39 | CF2CF3 | CF3 | Me | H | H | H | C—H | C—H | C—F | C—H | O | cyclopropyl |
| Ic-40 | CF2CF3 | CF3 | Me | H | H | H | C—F | C—H | C—H | C—H | O | 1-cyanocyclopropyl |
| Ic-41 | CF2CF3 | CF3 | Me | H | H | H | C—H | C—H | C—H | C—F | O | cyclopropyl |
| Ic-42 | CF2CF3 | CF3 | Me | H | H | H | C—H | C—H | C—H | C—F | O | 1-cyanocyclopropyl |
| Ic-43 | CF2CF3 | CF3 | Me | H | H | H | C—H | C—H | C—Cl | C—H | O | 1-cyanocyclopropyl |
| Ic-44 | CF2CF3 | CF3 | Me | H | H | H | C—H | C—H | C—Cl | C—H | O | cyclopropyl |
| Ic-45 | CF2CF3 | CF3 | Me | H | H | H | C—H | C—H | C—H | C—Cl | O | 1-cyanocyclopropyl |
| Ic-46 | CF2CF3 | CF3 | Me | H | H | H | C—H | C—H | C—H | C—Cl | O | cyclopropyl |
| Ic-47 | CF2CF3 | CF3 | Me | H | H | H | C—H | C—F | C—F | C—H | O | 1-cyanocyclopropyl |
| Ic-48 | CF2CF3 | CF3 | Me | H | H | H | C—H | C—F | C—H | C—Cl | O | 1-cyanocyclopropyl |
| Ic-49 | CF2CF3 | CF3 | Me | H | H | H | C—H | C—F | C—H | C—Cl | O | cyclopropyl |
| Ic-50 | CF3 | (E/Z) (hydroxyimino)methyl | Me | H | H | H | C—H | C—Cl | C—H | C—H | O | cyclopropyl |
| Ic-51 | CF3 | (E/Z) | Me | H | H | H | C—H | C—Cl | C—H | C—H | O | cyclopropyl |
| | | (methoxyimino)methyl | | | | | | | | | | |
| Ic-52 | CF3 | formyl | Me | H | H | H | C—H | C—Cl | C—H | C—H | O | cyclopropyl |
| Ic-53 | CF3 | CN | Me | H | H | H | C—H | C—Cl | C—H | C—H | O | 1-cyanocyclopropyl |
| Ic-54 | CF2CF3 | CF3 | Me | H | H | H | C—H | C—H | C—Me | C—H | O | cyclopropyl |
| Ic-55 | CF2CF3 | CF3 | Me | H | H | H | C—H | C—F | C—F | C—H | O | cyclopropyl |
| Ic-56 | CF2CF3 | CF3 | Me | H | H | H | C—H | C—H | C—Me | C—H | O | 1-cyanocyclopropyl |
| Ic-57 | CF2CF3 | CF3 | Me | H | H | H | C—H | C—H | C—H | C—Me | O | cyclopropyl |
| Ic-58 | CF2CF3 | CF3 | Me | H | H | H | C—H | C—H | C—H | C—Me | O | 1-cyanocyclopropyl |
| Ic-59 | CF2CF3 | CF3 | Me | H | H | H | C—H | C—H | C—CF3 | C—H | O | cyclopropyl |
| Ic-60 | CF2CF3 | CF3 | Me | H | H | H | C—H | C—H | C—CF3 | C—H | O | 1-cyanocyclopropyl |
| Ic-61 | CF2CF3 | CF3 | Me | H | H | H | C—H | C—H | C—F | C—F | O | cyclopropyl |
| Ic-62 | CF2CF3 | CF3 | Me | H | H | H | C—H | C—H | C— | C—H | O | cyclopropyl |
| Ic-63 | CF2CF3 | CF3 | Me | H | H | H | C—H | C—H | C—OMe | C—H | O | 1-cyanocyclopropyl |
| Ic-64 | CF2CF3 | CF3 | Me | H | H | H | C—H | C—H | C—F | C—F | O | 1-cyanocyclopropyl |
| Ic-65 | CF2CF3 | CF3 | Me | H | H | H | C—H | C—N02 | C—H | C—H | O | 1-cyanocyclopropyl |
| Ic-66 | CF2CF3 | CF3 | Me | H | H | H | C—H | C—N02 | C—H | C—H | O | cyclopropyl |
| Ic-67 | CF2CF3 | CF3 | Me | H | H | H | C—H | C—OMe | C—H | C—H | O | 1-cyanocyclopropyl |
| Ic-68 | CF2CF3 | CF3 | Me | H | H | H | C—H | C—OMe | C—H | C—H | O | cyclopropyl |
| Ic-69 | CF3 | CH2OH | Me | H | H | H | C—H | C—Cl | C—H | C—H | O | cyclopropyl |
| Ic-70 | CF2CF3 | CF3 | Me | H | H | H | C—H | C—H | N | C—H | O | cyclopropyl |
| Ic-71 | CF2CF3 | CF3 | Me | H | H | H | C—H | C—H | N | C—H | O | 1-cyanocyclopropyl |
| Ic-72 | CF2CF3 | CF3 | Me | H | H | H | C—H | N | C—H | C—F | O | cyclopropyl |
| Ic-73 | CF2CF3 | CF3 | Me | H | H | H | C—H | N | C—H | C—F | O | 1-cyanocyclopropyl |
| Ic-74 | CF2CF3 | CF3 | Me | H | H | H | C—H | C—H | C—OCF3 | C—H | O | cyclopropyl |
| Ic-75 | CF2CF3 | CF3 | Me | H | H | H | C—H | C—H | C—OCF3 | C—H | O | 1-cyanocyclopropyl |
| Ic-76 | CF2CF3 | CF3 | Me | H | H | H | C—H | N | C—H | C—H | O | 1-cyanocyclopropyl |
| Ic-77 | CF2CF3 | CF3 | Me | H | H | H | C—H | C—Cl | C—H | C—H | O | 2-fluoroethyl |
| Ic-78 | CF2CF3 | CF3 | Me | H | H | H | C—H | C—Cl | C—H | C—H | O | 2,2-difluoroethyl |
| Ic-79 | CF2CF3 | CF3 | Me | H | H | H | C—H | C—Cl | C—H | C—H | O | 2-methylcyclopropyl |
| Ic-80 | CF2CF3 | CF3 | Me | H | H | H | C—H | C—Cl | C—H | C—H | O | 2,2-difluoropropyl |
| Ic-81 | CF2CF3 | CF3 | Me | H | H | H | C—H | C—Cl | C—H | C—H | O | 2-fluorocyclopropyl |
| Ic-83 | CF2CF3 | CF3 | Me | H | H | H | C—H | C—Cl | N | C—H | O | 1-cyanocyclopropyl |
| Ic-84 | CF2CF3 | CF3 | Me | H | H | H | C—H | C—Me | N | C—H | O | cyclopropyl |
| Ic-85 | CF2CF3 | CF3 | Me | H | H | H | C—H | C—Me | N | C—H | O | 1-cyanocyclopropyl |
| Ic-86 | CF2CF3 | CF3 | Me | H | H | H | C—H | C—OMe | N | C—H | O | cyclopropyl |
| Ic-87 | CF2CF3 | CF3 | Me | H | H | H | C—H | C—OMe | N | C—H | O | 1-cyanocyclopropyl |
| Ic-88 | CF2CF3 | CF3 | Me | H | H | H | C—H | N | C—Cl | C—H | O | cyclopropyl |
| Ic-89 | CF2CF3 | CF3 | Me | H | H | H | C—H | N | C—Cl | C—H | O | 1-cyanocyclopropyl |
| Ic-90 | CF2CF3 | CF3 | Me | H | H | H | C—H | C—Cl | C—Me | C—H | O | cyclopropyl |
| Ic-91 | CF2CF3 | CF3 | Me | H | H | H | C—H | C—Cl | C—Me | C—H | O | 1-cyanocyclopropyl |
| Ic-92 | CF2CF3 | CF3 | Me | H | H | H | C—H | C—Cl | C—H | C—F | O | cyclopropyl |
| Ic-93 | CF2CF3 | CF3 | Me | H | H | H | C—H | C—Cl | C—H | C—F | O | 1-cyanocyclopropyl |
| Ic-94 | CF2CF3 | CF3 | Me | H | H | H | C—H | C—Cl | C—Cl | C—H | O | cyclopropyl |
| Ic-95 | CF2CF3 | CF3 | Me | H | H | H | C—H | C—Cl | C—Cl | C—H | O | 1-cyanocyclopropyl |
| Ic-96 | CF2CF3 | CF3 | Me | Me | H | H | C—H | C—Cl | C—H | C—H | O | 1-cyanocyclopropyl |
| Ic-97 | CF2CF3 | CF3 | Me | Me | H | H | C—H | C—Cl | C—H | C—H | O | 1- |
| Ic-98 | CF3 | (E/Z) | Me | H | H | H | C—H | C—Cl | C—H | C—H | O | 1-cyanocyclopropyl |
| | | (hydroxyimino)methyl | | | | | | | | | | |
| Ic-99 | CF3 | (E/Z) | Me | H | H | H | C—H | C—Cl | C—H | C—H | O | 1-cyanocyclopropyl |
| | | (methoxyimino)methyl | | | | | | | | | | |
| Ic-100 | CF3 | cyclopropylcarbamoyl | Me | H | H | H | C—H | C—Cl | C—H | C—H | O | cyclopropyl |
| Ic-101 | CF3 | cyclopropylcarbamoyl | Me | H | H | H | C—H | C—Cl | C—H | C—H | O | 1-cyanocyclopropyl |
| Ic-102 | CF3 | formyl | Me | H | H | H | C—H | C—Cl | C—H | C—H | O | 1-cyanocyclopropyl |
| Ic-103 | CF3 | CH2F | Me | H | H | H | C—H | C—Cl | C—H | C—H | O | cyclopropyl |
| Ic-104 | CF3 | CH2OH | Me | H | H | H | C—H | C—Cl | C—H | C—H | O | 1-cyanocyclopropyl |
| Ic-105 | CF2CF3 | CF3 | Me | H | H | H | N | C—H | C—H | C—H | O | 1-cyanocyclopropyl |
| Ic-106 | CF2CF3 | CF3 | Me | H | H | H | C—F | C—Cl | C—H | C—H | O | cyclopropyl |
| Ic-107 | CF2CF3 | CF3 | Me | H | H | H | C—F | C—Cl | C—H | C—H | O | 1-cyanocyclopropyl |
| Ic-108 | CF2CF3 | CF3 | Me | H | H | H | C—H | C—Cl | C—H | C—H | O | 3- |
| | | | | | | | | | | | | (methylsulfanyl)cyclobutyl |
| Ic-109 | CF2CF3 | CF3 | Me | H | H | H | C—H | C—Cl | C—H | C—H | O | prop-2-yn-1-yl |
| Ic-110 | CF2CF3 | CF3 | Me | H | H | H | C—H | C—Cl | C—H | C—H | O | 1,1,1-trifluoropropan-2-yl |
| Ic-111 | CF2CF3 | CF3 | Me | H | H | H | C—H | C—Cl | C—H | C—H | O | buta-2,3-dien-1-yl |
| Ic-112 | CF2CF3 | CF3 | Me | H | H | H | C—H | C—Cl | C—H | C—H | O | 3-chloroprop-2-en-1-yl |
| Ic-113 | CF2CF3 | CF3 | Me | H | H | H | C—H | C—Cl | C—H | C—H | O | isopropyl |
| Ic-114 | CF3 | CH2Cl | Me | H | H | H | C—H | C—Cl | C—H | C—H | O | cyclopropyl |
| Ic-115 | CF3 | CH2F | Me | H | H | H | C—H | C—Cl | C—H | C—H | O | 1-cyanocyclopropyl |
| Ic-116 | CF2CF3 | CF3 | Me | H | H | H | C—H | C—Cl | C—H | C—H | O | 1-oxidothietan-3-yl |
| Ic-117 | CF2CF3 | CF3 | Me | H | H | H | C—H | C—Cl | C—H | C—H | O | 1,1-dioxidothietan-3-yl |
| Ic-118 | CF2CF3 | CF3 | Me | H | H | H | C—H | C-(E/Z)- | C—H | C—H | O | cyclopropyl |
| | | | | | | | | (methoxyimino)met | | | | |
| Ic-119 | CF2CF3 | CF3 | Me | H | H | H | C—H | C—Cl | C—H | C—H | O | 2- |
| | | | | | | | | | | | | (methylsulfanyl)cyclobutyl |
| Ic-120 | CF2CF3 | CF3 | Me | H | H | H | C—H | C—Cl | C—H | C—H | O | 2- |
| | | | | | | | | | | | | [(methylsulfanyl)methyl]cyclobutyl |
| Ic-121 | CF2CF3 | formyl | Me | H | H | H | C—H | C—Cl | C—H | C—H | O | 1-cyanocyclopropyl |
| Ic-122 | CF2CF3 | CF3 | Me | H | H | H | C—H | C—Cl | C—H | C—H | O | 3- |
| | | | | | | | | | | | | (methylsulfonyl)cyclobutyl |
| Ic-123 | CF2CF3 | CF3 | Me | H | H | H | C—H | C—Cl | C—H | C—H | O | 2- |
| | | | | | | | | | | | | [(methylsulfinyl)methyl]cyclobutyl |
| Ic-124 | CF2CF3 | CF3 | Me | H | H | H | C—H | C—Cl | C—H | C—H | O | (1S,2R)-2- |
| | | | | | | | | | | | | (methylsulfonyl)cyclobutyl |
| Ic-125 | CF2CF3 | CF3 | Me | H | H | H | C—H | C—Cl | C—H | C—H | O | 2- |
| | | | | | | | | | | | | (methylsulfinyl)cyclobutyl |
| Ic-126 | CF3 | CF3 | Me | H | H | H | C—H | C—Cl | C—H | C—H | O | cyclopropyl |
| Ic-127 | CF3 | CF3 | Me | H | H | H | C—H | C—Cl | C—H | C—H | O | 1-cyanocyclopropyl |
| Ic-128 | CF2CF3 | CF3 | Me | H | H | H | C—H | C—Cl | C—H | C—H | O | 3-cyanothietan-3-yl |
| Ic-129 | CF2CF3 | CF3 | Me | H | H | H | C—H | C—Me | C—H | C—H | O | 1-cyanocyclopropyl |
| Ic-130 | CF2CF3 | CF3 | Me | H | H | H | C—H | C—Me | C—H | C—H | O | cyclopropyl |
| Ic-131 | CF2CF3 | CF3 | Me | H | H | H | C—H | C—Me | C—H | C—H | O | 4-fluorophenyl |
| Ic-132 | CF2CF3 | CF3 | Me | H | H | H | C—H | C—Cl | C—H | C—H | S | cyclopropyl |
| Ic-133 | CF3 | CHF2 | Me | H | H | H | C—H | C—Cl | C—H | C—H | O | cyclopropyl |
| Ic-134 | CF3 | S(O)Me | Me | H | H | H | C—H | C—Cl | C—H | C—H | O | 1-cyanocyclopropyl |
| Ic-135 | CF3 | CF3 | Me | H | H | H | C—H | C—Cl | C—H | C—H | O | phenyl |
| Ic-136 | CF2CF3 | CF3 | Me | H | H | H | C—H | C—Cl | C—H | C—H | O | phenyl |
| Ic-137 | CF2CF3 | CF3 | Me | H | H | H | C—H | C—Cl | C—H | C—H | O | 3-methylbutan-2-yl |
| Ic-138 | CF2CF3 | CF3 | Me | H | H | H | C—H | C—Cl | C—H | C—H | O | 2-(dimethylamino)ethyl |
| Ic-139 | CF2CF3 | CF3 | Me | H | H | H | C—H | C—Cl | C—H | C—H | O | 2-methoxyethyl |
| Ic-140 | CF2CF3 | CF3 | Me | H | H | H | C—H | C—Cl | C—H | C—H | O | pyridin-2-yl |
| Ic-141 | CF2CF3 | CF3 | Me | H | H | H | C—H | C—Cl | C—H | C—H | O | cyclopentyl |
| Ic-142 | CF2CF3 | CF3 | Me | H | H | H | C—H | C—Cl | C—H | C—H | O | isobutyl |
| Ic-143 | CF2CF3 | CF3 | Me | H | H | H | C—H | C—Cl | C—H | C—H | O | cyclobutyl |
| Ic-144 | CF2CF3 | CF3 | Me | H | H | H | C—H | C—Cl | C—H | C—H | O | 1H-tetrazol-5-yl |
| Ic-145 | CF2CF3 | CF3 | Me | H | H | H | C—H | C—Cl | C—H | C—H | O | 1,2-oxazol-3-yl |
| Ic-146 | CF2CF3 | CF3 | Me | H | H | H | C—H | C—Cl | C—H | C—H | O | 1H-imidazol-2-ylmethyl |
| Ic-147 | CF2CF3 | CF3 | Me | H | H | H | C—H | C—Cl | C—H | C—H | O | cyanomethyl |
| Ic-148 | CF2CF3 | CF3 | Me | H | H | H | C—H | C—Cl | C—H | C—H | O | 5-methyl-1,2-oxazol-3-yl |
| Ic-149 | CF2CF3 | CF3 | Me | H | H | H | C—H | C—Cl | C—H | C—H | O | pyridin-3-yl |
| Ic-150 | CF2CF3 | CF3 | Me | H | H | H | C—H | C—Cl | C—H | C—H | O | 1H-pyrazol-3-yl |
| Ic-151 | CF2CF3 | CF3 | Me | H | H | H | C—H | C—Cl | C—H | C—H | O | 3-chloropropyl |
| Ic-152 | CF2CF3 | CF3 | Me | H | H | H | C—H | C—Cl | C—H | C—H | O | methyl |
| Ic-153 | CF2CF3 | CF3 | Me | H | H | H | C—H | C—Cl | C—H | C—H | O | cyclopropylmethyl |
| Ic-154 | CF2CF3 | CF3 | Me | H | H | H | C—H | C—Cl | C—H | C—H | O | 1-amino-1-oxopropan-2-yl |
| Ic-155 | CF2CF3 | CF3 | Me | H | H | H | C—H | C—Cl | C—H | C—H | O | methoxy |
| Ic-156 | CF2CF3 | CF3 | Me | H | H | H | C—H | C—Cl | C—H | C—H | O | 2-amino-2-oxoethyl |
| Ic-157 | CF2CF3 | CF3 | Me | H | H | H | C—H | C—Cl | C—H | C—H | O | 1H-pyrazol-3-ylmethyl |
| Ic-158 | CF2CF3 | CF3 | Me | H | H | H | C—H | C—Cl | C—H | C—H | O | 5-methyl-1,3,4-oxadiazol- |
| | | | | | | | | | | | | 2-yl |
| Ic-159 | CF2CF3 | CF3 | Me | H | H | H | C—H | C—Cl | C—H | C—H | O | 1-methyl-1H-pyrazol-3-yl |
| Ic-160 | CF2CF3 | CF3 | Me | H | H | H | C—H | C—Cl | C—H | C—H | O | 4-methyl-1,3-oxazol-2-yl |
| Ic-161 | CF2CF3 | CF3 | Me | H | H | H | C—H | C—Cl | C—H | C—H | O | 1-cyclopropylpropan-2-yl |
| Ic-162 | CF2CF3 | CF3 | Me | H | H | H | C—H | C—Cl | C—H | C—H | O | 5-hydroxy-1H-pyrazol-3- |
| Ic-163 | CF2CF3 | CF3 | Me | H | H | H | C—H | C—Cl | C—H | C—H | O | 1-methyl-1H-pyrazol-5-yl |
| Ic-164 | CF2CF3 | CF3 | Me | H | H | H | C—H | C—Cl | C—H | C—H | O | (3R)-tetrahydrofuran-3-yl |
| Ic-165 | CF2CF3 | CF3 | Me | H | H | H | C—H | C—Cl | C—H | C—H | O | 1-methoxypropan-2-yl |
| Ic-166 | CF2CF3 | CF3 | Me | H | H | H | C—H | C—Cl | C—H | C—H | O | 1-methyl-1H-pyrazol-4-yl |
| Ic-167 | CF2CF3 | CF3 | Me | H | H | H | C—H | C—Cl | C—H | C—H | O | 2-(methylsulfanyl)ethyl |
| Ic-168 | CF3 | CF3 | Me | H | H | H | C—H | C—Cl | C—H | C—H | O | 2-fluoroethyl |
| Ic-169 | CF3 | CF3 | Me | H | H | H | C—H | C—Cl | C—H | C—H | O | 2,2,2-trifluoroethyl |
| Ic-170 | CF3 | CF3 | Me | H | H | H | C—H | C—Cl | C—H | C—H | O | 2,2-difluoroethyl |
| Ic-171 | CF2CF3 | CF3 | Me | H | H | H | C—H | C—H | H | C-0- | O | cyclopropyl |
| | | | | | | | | | | CF2-0-C | | |
| Ic-172 | CF2CF3 | CF3 | Me | H | H | H | C—H | C—H | H | C-0- | O | 1-cyanocyclopropyl |
| | | | | | | | | | | CF2-0-C | | |
| Ic-173 | CF2CF3 | CF3 | Me | H | H | H | C—H | C—F | C- | C—H | O | cyclopropyl |
| | | | | | | | | | sulfamoyl | | | |
| Ic-174 | CF2CF3 | CF3 | Me | H | H | H | C—F | C—F | C—H | C—H | O | cyclopropyl |
| Ic-175 | CF2CF3 | CF3 | Me | H | H | H | C—F | C—F | C—H | C—H | O | 1-cyanocyclopropyl |
| Ic-176 | CF2CF3 | CF3 | Me | H | H | H | C—H | C—Cl | C—H | C—H | O | 1-ethoxycyclopropyl |
| Ic-177 | CF3 | CF3 | Me | H | H | H | C—H | C—Cl | C—H | C—H | O | 2-fluorocyclopropyl |
| Ic-178 | CF2CF3 | CF3 | Me | H | H | H | N | C—H | N | C—H | O | cyclopropyl |
| Ic-179 | CF2CF3 | CF3 | Me | H | H | H | N | C—H | N | C—H | O | 1-cyanocyclopropyl |
| Ic-180 | CF2CF3 | CF3 | Me | H | H | H | C—H | C—Cl | C—H | C—H | O | (1R,2R)-2- |
| | | | | | | | | | | | | ethoxycyclopropyl |
| Ic-181 | CF2CF3 | CF3 | Me | H | H | H | C—H | C—Cl | C—H | C—H | O | 2-(CF3)cyclopropyl |
| Ic-182 | CF2CF3 | CF3 | Me | H | H | H | C—H | C—SMe | C—H | C—H | O | cyclopropyl |
| Ic-183 | CF2CF3 | CF3 | Me | H | H | H | C—H | C—Cl | C—H | C—H | O | (1S,2S,3S)-2-ethoxy-3- |
| | | | | | | | | | | | | methylcyclopropyl |
| Ic-184 | CF2CF3 | CF3 | Me | H | H | H | C—H | C—Cl | C—H | C—H | O | 2,2-dichlorocyclopropyl |
| Ic-185 | CF2CF3 | CF3 | Me | H | H | H | C—H | C- | C—H | C—H | O | cyclopropyl |
| | | | | | | | | diethylsulfamoyl | | | | |
| Ic-186 | CF2CF3 | CF3 | Me | H | H | H | C—H | C—Cl | C—H | C—H | O | (1S,28)-2- |
| | | | | | | | | | | | | ethoxycyclopropyl |
| Ic-187 | CF2CF3 | CF3 | Me | H | H | H | C—H | C—Cl | C—H | C—H | O | 1-methoxycyclopropyl |
| Ic-188 | CF2CF3 | CF3 | Me | H | H | H | C—H | C—Cl | C—H | C—H | O | 1,1′-bi(cyclopropyl)-1-yl |
| Ic-189 | CF2CF3 | CF3 | Me | H | H | H | C—H | C—S(O)Me | C—H | C—H | O | cyclopropyl |
| Ic-190 | CF2CF3 | CF3 | Me | H | H | H | C—H | C—S(0)2Me | C—H | C—H | O | cyclopropyl |
| Ic-191 | CF2CF3 | CF3 | Me | H | H | amino | C—H | C—Cl | C—H | C—H | O | 1-cyanocyclopropyl |
| Ic-192 | CF2CF3 | CF3 | Me | H | H | amino | C—H | C—Cl | C—H | C—H | O | cyclopropyl |
| Ic-193 | CF2CF3 | CF3 | Me | H | H | H | C—H | C—Cl | C—H | C—H | O | but-3-yn-2-yl |
| Ic-194 | CF2CF3 | SMe | Me | H | H | H | C—H | C—Cl | C—H | C—H | O | 1-cyanocyclopropyl |
| Ic-195 | CF2CF3 | CF3 | Me | H | H | H | C—H | C—Cl | C- | C—H | O | cyclopropyl |
| | | | | | | | | | sulfamoyl | | | |
| Ic-196 | CF2CF3 | CF3 | Me | H | H | H | C—H | C—CF3 | C—H | C—H | O | cyclopropyl |
| Ic-197 | CF2CF3 | CF3 | Me | Et | H | H | C—H | C- | C—H | C—H | O | ethyl |
| | | | | | | | | cyclopropylsulfamoyl | | | | |
| Ic-198 | CF2CF3 | CF3 | Me | H | H | H | C—H | C—Cl | C—H | C—H | O | pent-3-yn-2-yl |
| Ic-199 | CF2CF3 | CF3 | Me | Me | H | H | C—H | C—Cl | C—H | C—H | O | cyclopropyl |
| Ic-200 | CF2CF3 | CF3 | Me | H | H | H | C—H | C—Cl | C—H | C—H | O | 1-methylcyclopropyl |
| Ic-201 | CF2CF3 | CF3 | Me | H | H | H | C—H | C—F | C—F | C—F | O | cyclopropyl |
| Ic-202 | CF2CF3 | CF3 | Me | H | H | H | C—H | C—F | C—F | C—F | O | 1-cyanocyclopropyl |
| Ic-203 | CF2CF3 | CF3 | Me | H | H | H | C—H | C—CF3 | C—H | C—H | O | 1-cyanocyclopropyl |
| Ic-204 | CF2CF3 | CF3 | Me | nPr | H | H | C—H | C—Cl | C—H | C—H | O | 1-cyanocyclopropyl |
| Ic-205 | CF2CF3 | CF3 | Me | propionyl | H | H | C—H | C—Cl | C—H | C—H | O | 1-cyanocyclopropyl |
| Ic-206 | CF2CF3 | CF3 | Me | allyl | H | H | C—H | C—Cl | C—H | C—H | O | 1-cyanocyclopropyl |
| Ic-207 | CF2CF3 | CF3 | Me | H | H | H | C—H | C—Cl | C—H | C—H | O | 1-cyclopropylethyl |
| Ic-208 | CF2CF3 | CF3 | Me | Et | H | H | C—H | C—Cl | C—H | C—H | O | 1-cyanocyclopropyl |
| Ic-209 | CF2CF3 | CF3 | Me | H | H | H | C—H | C—Cl | C—H | C—H | O | 4-fluorophenyl |
| Ic-210 | CF2CF3 | CF3 | Me | H | H | H | C—H | C—Cl | C—H | C—H | O | 1-cyclobutylcyclopropyl |
| Ic-211 | CF2CF3 | CF3 | Me | Et | H | H | C—H | C—Cl | C—H | C—H | O | cyclopropyl |
| Ic-212 | CF2CF3 | CF3 | Me | H | H | H | C—H | C—Cl | C—H | N | O | cyclopropyl |
| Ic-213 | CF2CF3 | CF3 | Me | H | H | H | C—H | C—Cl | C—H | N | O | 1-cyanocyclopropyl |
| Ic-214 | CF2CF3 | CF3 | Me | H | H | H | C—H | C—Cl | C—H | C—H | O | pyrazin-2-yl |

or an agrochemically acceptable salt or N-oxide thereof.

6. The method according to claim 1, wherein the compound is selected from

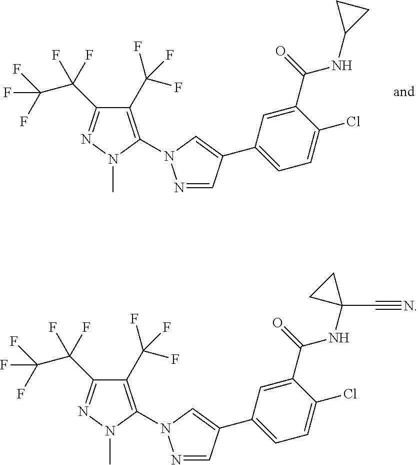 [SMILES: Cn1nc(C(F)(F)C(F)(F)F)c(C(F)(F)F)c1-n1cc(-c2ccc(Cl)c(C(=O)NC3CC3)c2)cn1 ; Cn1nc(C(F)(F)C(F)(F)F)c(C(F)(F)F)c1-n1cc(-c2ccc(Cl)c(C(=O)NC3(C#N)CC3)c2)cn1]

7. A method according to claim 1, wherein the stinkbug is selected from Nezara spp. (e.g. Nezara viridula, Nezara antennata, Nezara hilare), Piezodorus spp. (e.g. Piezodorus guildinii), Acrosternum spp. (e.g. Acrosternum hilare), Euchistus spp. (e.g. Euchistus heros, Euschistus servus), Halymorpha spp. (e.g. Halyomorpha halys), Plautia crossota, Riptortus clavatus, Rhopalus msculatus, Antestiopsis spp. (e.g. Antestiopsis orbitalus), Dichelops spp. (e.g. Dichelops furcatus, Dichelops melacanthus), Edessa spp. (e.g. Edessa meditabunda), Eurygaster spp. (e.g. Eurygaster intergriceps, Eurygaster maura), Murgantia spp., Oebalus spp. (e.g. Oebalus mexicana, Oebalus poecilus, Oebalus pugnase, Oebalus pugnax), Thianta spp., Pentatomidae, Lygus spp. (e.g. Lygus lineolaris, Lygus hesperus, Lygus elisus), Thyanta spp., Tibraca spp. and Scotinophara spp. (e.g. Scotinophara lurida, Scotinophara coarctata).

8. A method according to claim 1, wherein the stinkbug is from the genus Euschistus.

9. The method according to claim 1, wherein the stinkbug is Euschistus heros.

10. (canceled)

11. (canceled)

12. (canceled)

13. (canceled)

14. A method for obtaining regulatory approval for the use of a compound as defined in claim 1 for controlling and/or preventing infestation of stinkbugs, particularly Euschistus spp., comprising at least one step of referring to, submitting or relying on biological data showing that said active ingredient reduces stinkbug pressure.

15. The method according to claim 1, wherein the plant is selected from soybean, sorghum, sunflower, sugarbeet, cereals, coffee, cocoa, corn, cotton, citrus fruits, grapes, potato, rice, sugarcane and vegetables.

16. The method according claim 1, wherein the plant is selected from soybean and sunflower, in particular soybean.

17. A method for growing soybean comprising applying or treating soybean or a seed thereof with a compound as defined in claim 1.
